(19) United States
(12) Patent Application Publication
(10) Pub. No.: US 2019/0391109 A1
(43) Pub. Date: Dec. 26, 2019

(54) GAS SENSOR

(71) Applicant: DENSO CORPORATION, Kariya-city (JP)

(72) Inventors: Shota HAGINO, Nisshin-city (JP); Masatoshi IKEDA, Nisshin-city (JP); Makoto ITO, Kariya-city (JP); Zhenzhou SU, Kariya-city (JP); Hao WU, Nisshin-city (JP); Takashi HIRAYAMA, Kariya-city (JP); Daisuke KAWAI, Kariya-city (JP); Satoshi NAKAMURA, Nisshin-city (JP)

(21) Appl. No.: 16/451,285

(22) Filed: Jun. 25, 2019

(30) Foreign Application Priority Data
Jun. 26, 2018 (JP) 2018-121176
Jan. 22, 2019 (JP) 2019-008692

(51) Int. Cl. G01N 27/407; G01N 27/409

(52) U.S. Cl. CPC G01N 27/4072; G01N 27/4075; F01N 2560/20; G01N 27/409; F01N 2560/02; G01N 27/4077

(57) ABSTRACT

A gas sensor is equipped with a sensor device made of a stack of a solid electrolyte body, a sensor electrode, a reference electrode, a first insulator, a second insulator, a gas chamber, a reference gas duct, a heater, and a heat transfer member. The heater has a heating element at least partially overlapping the sensor electrode and the reference electrode. The heat transfer member is made of a dense metallic oxide material which blocks passage of measurement gas therethrough. The heat transfer member is held between the sensor electrode and the first insulator in which the heater is embedded within the gas chamber and works to facilitate transfer of thermal energy, as generated by the heater, to the solid electrolyte body, the sensor electrode, and the reference electrode. This results in enhanced thermal conductivity of the sensor device and achieves quick activation of the sensor device.

### CROSS REFERENCE TO RELATED DOCUMENT

The present application claims the benefit of priority of Japanese Patent Application No. 2018-121176 filed on Jun. 26, 2018 and Japanese Patent Application No. 2019-8692 filed on Jan. 22, 2019, disclosures of which are incorporated herein by reference.

### BACKGROUND

### 1 Technical Field

This disclosure relates generally to a gas sensor equipped with a planar sensor device.

### 2 Background Art

Gas sensors are installed in, for example, an exhaust pipe of an internal combustion engine to measure the concentration of a given gas component, such as oxygen, contained in exhaust gas flowing in the exhaust pipe. The gas sensors usually include a sensor device installed therein. The sensor device typically includes a solid electrolyte body which has an oxygen ion conductivity, a sensor electrode, and a reference electrode. The sensor electrode and the reference electrode are affixed to opposed major surfaces of the solid electrolyte body. The solid electrolyte body has stacked therein an insulator which has embedded therein a heater which produces heat when supplied with electric power. The heater has a heating element which faces the electrodes of the sensor device and works to heat the sensor electrode, the reference electrode, and a portion of the solid electrolyte body interposed between the sensor electrode and the reference electrode up to a given activation temperature.

### SUMMARY

It is an object of this disclosure to provide a gas sensor which is capable of enhancing thermal conductivity of a sensor device to accelerate activation of the sensor device.

According to a first aspect of this disclosure, there is provided a gas sensor which comprises: a sensor device which is of a planar shape; and a heat transfer member. The sensor device includes (a) a solid electrolyte body which has oxygen ion conductivity, (b) a pair of electrodes which are disposed on a surface of the solid electrolyte body, (c) an insulator which is stacked on the solid electrolyte body, (d) a gas space which is enclosed by the insulator and located adjacent the solid electrolyte body, in which one of the electrodes is disposed, and into which a measurement gas or a reference gas is introduced, and (e) a heater which includes a heating element and a pair of leads connecting with the heating element. The heating element is energized to produce heat when supplied with electric power and laid to at least partially overlap the electrodes on the solid electrolyte body in a stacking direction in which the solid electrolyte body and the insulator are stacked. The heater is embedded in the insulator.

The heat transfer member is made of a dense metallic oxide which blocks passage of the measurement gas therethrough. The heat transfer member is held between the insulator and one of the electrodes or among the insulator, one of the electrodes, and the solid electrolyte body within a portion of the gas space. The heat transfer member works to achieve transfer of the heat from the heating element to the solid electrolyte body and the electrodes.

According to a second aspect of this disclosure, there is provided a gas sensor which comprises: a sensor device which has a length and is of a planar shape; and a heat transfer member. The sensor device includes (a) a solid electrolyte body which has oxygen ion conductivity, the solid electrolyte body having a length with a front end portion and a rear end portion, the solid electrolyte body also having a first major surface exposed to a measurement gas and a second major surface exposed to a reference gas, (b) a sensor electrode which is disposed on the first major surface of the front end portion of the solid electrolyte body, (c) a reference electrode which is disposed on the second major surface of the front end portion of the solid electrolyte body, (d) a first insulator which is stacked on the first major surface of the solid electrolyte body, (e) a heater which includes a heating element and a pair of leads connecting with rear ends of the heating element, the heating element being energized to produce heat when supplied with electric power and laid to at least partially overlap the sensor electrode and the reference electrode in a stacking direction in which the solid electrolyte body and the first insulator are stacked, the heater being embedded in the first insulator, (f) a gas chamber which is formed in the first insulator and located adjacent the first major surface of the solid electrolyte body, the gas chamber having the sensor electrode disposed therein, (g) a diffusion resistor which is arranged in the first insulator in communication with the gas chamber and through which the measurement gas is delivered into the gas chamber at a given diffusion rate, (h) a second insulator which is staked on the second major surface of the solid electrolyte body, and (i) a reference gas duct which is formed in the second insulator and located adjacent the second surface of the solid electrolyte body and extends from a rear end opening formed in the second insulator to a portion of the second insulator to which the reference electrode is exposed. The rear end opening has the measurement gas delivered therethrough into the reference gas duct

The heat transfer member is made of a dense metallic oxide which blocks passage of the measurement gas therethrough. The heat transfer member is held between the first insulator and the sensor electrode or among the first insulator, the sensor electrode, and the solid electrolyte body within a portion of the gas chamber, the heat transfer member working to achieve transfer of the heat from the heating element to the solid electrolyte body, the sensor electrode, and the reference electrode.

According to a third aspect of this disclosure, there is provided a gas sensor which comprises: a sensor device which has a length and is of a planar shape; and a heat transfer member. The sensor device includes, (a) a first solid electrolyte body which has oxygen ion conductivity, the first solid electrolyte body having a length with a front end portion and a rear end portion aligned with the first end portion in a lengthwise direction of the sensor device, the first solid electrolyte body also having a first pump electrode and a second pump electrode which are disposed on the front end portion of the first solid electrolyte body and face each other, (b) a second solid electrolyte body which is arranged to face the first solid electrolyte body and has oxygen ion conductivity, the second solid electrolyte body having a length with a front end portion and a rear end portion aligned with the first end portion in the lengthwise direction, the second solid electrolyte body also having a sensor electrode and a reference electrode which are disposed on the front end portion of the second solid electrolyte body and face each other, (c) a first insulator which is stacked on a major surface of the first solid electrolyte body on which the first pump electrode is disposed, (d) a second insulator which is interposed between a major surface of the first solid electrolyte body on which the second pump electrode is disposed and a major surface of the second solid electrolyte body on which the sensor electrode is disposed, (e) a third insulator which is stacked on a major surface of the second solid electrolyte body on which the reference electrode is disposed, (f) a heater which includes a heating element and a pair of leads connecting with rear ends of the heating element, the heating element being energized to produce heat when supplied with electric power and laid to at least partially overlap the first pump electrode, the second pump electrode, the sensor electrode, and the reference electrode in a stacking direction in which the solid electrolyte body, the first insulator, the second insulator, and the third insulator are stacked, the heater being embedded in the third insulator, (g) a gas chamber which is enclosed by the first solid electrolyte body, the second solid electrolyte body, and the second insulator and in which the second pump electrode and the sensor electrode are disposed, and (h) a diffusion resistor which is arranged in the second insulator in communication with the gas chamber and through which the measurement gas is delivered into the gas chamber at a given diffusion rate.

The heat transfer member is made of a dense metallic oxide which blocks passage of the measurement gas therethrough. The heat transfer member is held between the second pump electrode and the sensor electrode or among the second pump electrode, the first solid electrolyte body, the sensor electrode, and the second solid electrolyte body within a portion of the gas chamber. The heat transfer member works to achieve transfer of the heat from the heating element to the first solid electrolyte body, the first pump electrode, and the second pump electrode.

The gas sensor in each aspect offers the following beneficial advantages.

### Gas Sensor in First Aspect

The gas sensor in the first aspect has the heater embedded in the insulator in which the gas space is defined. The heat transfer member is held between the insulator in which the heater is embedded and one of the electrodes or among the insulator, one of the electrodes, and the solid electrolyte body within a portion of the gas space. The heat transfer member is made of a dense metallic oxide which blocks passage of the measurement gas therethrough. The heat transfer member works to facilitate transfer of the heat from the heating element to the solid electrolyte body and the electrodes.

When the solid electrolyte body and the electrodes are heated by heat generated by the heating element, the heat is transferred to the solid electrolyte body and the electrodes through the insulator and also to the solid electrolyte body and the electrodes through the heat transfer member. In other words, the heat propagates through two thermal paths: one extending from the heating element to the solid electrolyte body and the electrodes, bypassing the gas space, and the second extending from the heating element directly to the solid electrolyte body and the electrodes through the heat transfer member.

The use of the heat transfer member, therefore, serves to enhance the thermal conductivity from the heating element to the solid electrolyte body and the electrodes, in other words, the heat-transfer performance of the sensor device. This also results in a shortened period of time required by the heating element to heat the sensor device up to a temperature at which the sensor device is activated to achieve a required degree of conductivity of oxygen ions therein in use of the gas sensor.

The structure of the gas sensor, therefore, enhances the heat transfer performance of the sensor device to achieve quick activation of the sensor device.

In a case where the heat transfer member is held between the insulator in which the heater is embedded, the electrodes, and the solid electrolyte body, the heat transfer member has a decreased area covering the electrodes, thereby reducing an increase in electrical resistance when the sensor device measures the measurement gas.

The heat transfer member may have a portion joined to the solid electrolyte body to enhance the strength of joining of the heat transfer member to the sensor device. This also enhances the heat conductivity of the sensor device. These beneficial effects are true of the gas sensors in the other aspects.

### Gas Sensor in Second Aspect

The gas sensor have the gas chamber and the reference gas duct. The heater is disposed in the first insulator which defines the gas chamber. The heat transfer member is disposed within the gas chamber. In other words, the heating element of the heater is located close to the solid electrolyte body and the electrodes. The heat transfer member which is arranged inside the gas chamber serves to transfer heat, as generated by the heating element, to the solid electrolyte body and the electrodes therethrough. This facilitates the transfer of heat from the heating element to the solid electrolyte body and the electrodes.

When the heat transfer member is retained by the first insulator, the sensor electrode, and the solid electrolyte body, it, like the gas sensor in the first aspect, reduces the electric resistance and enhances the joint strength.

### Gas Sensor in Third Aspect

The gas sensor is equipped the plurality of solid electrolyte bodies and the gas chamber. The heat transfer member is arranged in the gas chamber between the solid electrolyte bodies. This facilitates the transfer of thermal energy from the heater to the first solid electrolyte body which is one of the solid electrolyte bodies and located farther away from the third insulator in which the heater is embedded, the first pump electrode, and the second pump electrode.

The heat transfer member may be held among the second electrode, the first solid electrolyte body, the sensor electrode, and the second solid electrolyte body. This, like the gas sensor in the first aspect, reduces the electric resistance and enhances the joint strength.

In this disclosure, symbols in brackets represent correspondence relation between terms in claims and terms described in embodiments which will be discussed later, but are not limited only to parts referred to in the disclosure.

### BRIEF DESCRIPTION OF THE DRAWINGS

The present invention will be understood more fully from the detailed description given hereinbelow and from the accompanying drawings of the preferred embodiments of the invention, which, however, should not be taken to limit the invention to the specific embodiments but are for the purpose of explanation and understanding only.

In the drawings:

FIG. 1 is a longitudinal sectional view which illustrates a gas sensor according to the first embodiment;

FIG. 2 is an exploded perspective view which illustrates a sensor device installed in the gas sensor in FIG. 1;

FIG. 3 is a longitudinal sectional view of the sensor device in the first embodiment;

FIG. 4 is a sectional view taken along the line IV-IV in FIG. 3;

FIG. 5 is a partial sectional view which shows a sensor electrode, a heating element, and a heat transfer member installed in the gas sensor of FIG. 1;

FIG. 6 is a partial sectional view which shows a modification of a sensor electrode, a heating element, and a heat transfer member installed in the gas sensor of FIG. 1;

FIG. 7 is a partial sectional view which shows another modification of a sensor electrode, a heating element, and a heat transfer member installed in the gas sensor of FIG. 1;

FIG. 8 is a longitudinal sectional view which illustrates a sensor device according to the second embodiment;

FIG. 9 is a sectional view, as taken along the line IX-IX in FIG. 8, which shows a gas sensor according to the second embodiment;

FIG. 10 is a partial sectional view which illustrates a heating element meandering in a lengthwise direction of a gas sensor and a positional relation among a sensor electrode, the heating element, and a heat transfer member according to the third embodiment;

FIG. 11 is a partial sectional view which illustrates a modification of a sensor device which is different in layout of a sensor electrode, a heating element, and a heat transfer member from that in FIG. 10;

FIG. 12 is a partial sectional view which illustrates the second modification of a sensor device which is different in layout of a sensor electrode, a heating element, and a heat transfer member from that in FIG. 10;

FIG. 13 is a partial sectional view which illustrates the third modification of a sensor device which is different in layout of a sensor electrode, a heating element, and a heat transfer member from that in FIG. 10;

FIG. 14 is a partial sectional view which illustrates the fourth modification of a sensor device which is different in layout of a sensor electrode, a heating element, and a heat transfer member from that in FIG. 10;

FIG. 15 is a partial sectional view which illustrates a heating element meandering in a with-wise direction of a gas sensor in the third embodiment and a positional relation among a sensor electrode, the heating element, and a heat transfer member according to the third embodiment;

FIG. 16 is a partial sectional view which illustrates a modification of a sensor device which is different in layout of a sensor electrode, a heating element, and a heat transfer member from that in FIG. 15;

FIG. 17 is a partial sectional view which illustrates the second modification of a sensor device which is different in layout of a sensor electrode, a heating element, and a heat transfer member from that in FIG. 15;

FIG. 18 is a partial sectional view which illustrates the third modification of a sensor device which is different in layout of a sensor electrode, a heating element, and a heat transfer member from that in FIG. 15;

FIG. 19 is a partial sectional view which illustrates the fourth modification of a sensor device which is different in layout of a sensor electrode, a heating element not meandering, and a heat transfer member from that in FIG. 15;

FIG. 20 is a partial sectional view which illustrates the fifth modification of the sensor device in FIG. 19 which is different in layout of a sensor electrode, a heating element, and a heat transfer member from that in FIG. 19;

FIG. 21 is a partial sectional view which illustrates the sixth modification of the sensor device in FIG. 19 which is different in layout of a sensor electrode, a heating element, and a heat transfer member from that in FIG. 19;

FIG. 22 is a partial sectional view which illustrates the seventh modification of the sensor device in FIG. 19 which is different in layout of a sensor electrode, a heating element, and a heat transfer member from that in FIG. 19;

FIG. 23 is a partial section view which illustrates a sensor device according to the fourth embodiment;

FIG. 24 is a sectional view taken along the line XXIV-XXIV in FIG. 23;

FIG. 25 is a transverse sectional view, as taken along the line IV-IV in FIG. 3, which illustrates a sensor device according to the fifth embodiment;

FIG. 26 is a partial sectional view which illustrates a locational relation between a sensor electrode and a heat transfer member according to the fifth embodiment;

FIG. 27 is a graph which represents a relation between an overlap ratio and an electrical resistance ratio in the fifth embodiment;

FIG. 28 is a transverse sectional view, as taken along the line IV-IV in FIG. 3, which illustrates a sensor device according to the sixth embodiment;

FIG. 29 is a partial sectional view which illustrates layout of a sensor electrode and a heat transfer member installed in a sensor device according to the seventh embodiment;

FIG. 30 is a graph which represents a relation between a distance from a front end of a sensor electrode toward a base end side of a sensor device and an accumulated amount of electrical current in the seventh embodiment;

FIG. 31 is a graph which represents a relation between a distance from a front end of a sensor electrode toward a base end side of a sensor device and a response time in the seventh embodiment; and

FIG. 32 is a partial section view which illustrates a sensor device according to the seventh embodiment.

### DESCRIPTION OF THE PREFERRED EMBODIMENT

Prior to describing a gas sensor according to embodiments, a prior art gas sensor will be discussed.

Japanese Patent First Publication No. 2003-344350 discloses a gas sensor equipped with an oxygen sensor device which includes a solid electrolyte body made of a ceramic plate, a sensor electrode, and a reference electrode which are disposed on opposed surfaces of the solid electrolyte body. The solid electrolyte body has the reference electrode installed therein and also has formed therein an air inlet hole through which atmospheric air is delivered into the solid electrolyte body. The air inlet hole is filled with a porous ceramic.

The gas sensor is designed to measure an air-fuel ratio. The sensor device has formed therein a gas chamber in which the sensor electrode of the solid electrolyte body is arranged and into which a measurement gas, such as, exhaust gas, is introduced. The sensor device also has formed therein a reference gas duct in which the reference electrode of the solid electrolyte body is arranged and into which a reference gas, such as atmospheric air is delivered.

A gas-filled space, such as the gas chamber or the reference gas duct, is provided by a void cavity in the sensor device. The gas-filled space will, therefore, be a thermal insulator to minimize transfer of thermal energy from the heating element of the heater to the solid electrolyte body and the electrodes. Such a type of gas sensor is, therefore, required to be designed to facilitate the transfer of thermal energy from the heating element of the heater to the solid electrolyte body and the electrodes through the gas-filled space in order to accelerate the activation of the sensor device.

The porous ceramic mounted in the air inlet hole of the sensor device taught in the above publication is thought of as improving the transfer of thermal energy from the heating element to the solid electrolyte body and the electrodes, but however, it occupies the whole of the air inlet holes on the condition that air passes through the porous ceramic. The thermal conductivity of the air inlet hole, therefore, is still insufficient.

Embodiments of a gas sensor will be described below with reference to the drawings.

### First Embodiment

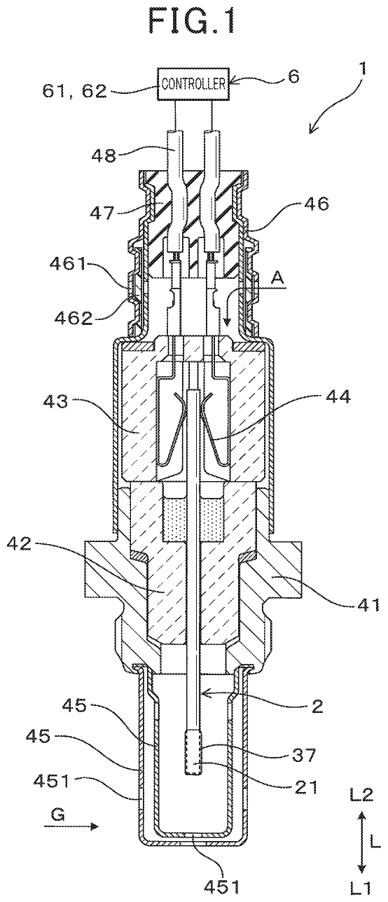

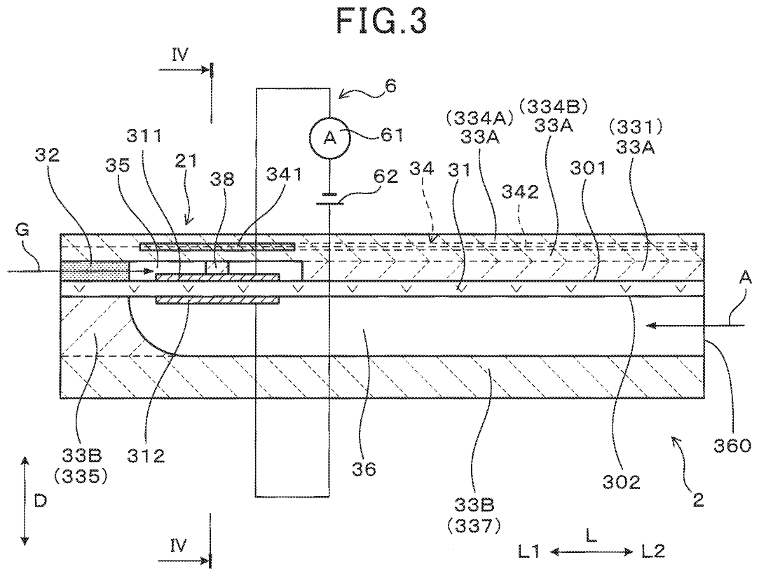

The gas sensor 1 of this embodiment, as clearly illustrated in FIGS. 1 and 3, is equipped with the sensor device 2 which has a given length and is of a rectangular planar or plate shape. The sensor device 2 works to measure gas. The sensor device 2 includes the solid electrolyte body 31, a pair of electrodes: the sensor electrode 311 and the reference electrode 312, the first insulator 33A, the second insulator 33B, the gas chamber 35, the reference gas duct 36, the heater 34, and the heat transfer member 38. The gas chamber 35 and the reference gas duct 36 are each designed as a gas-filled space.

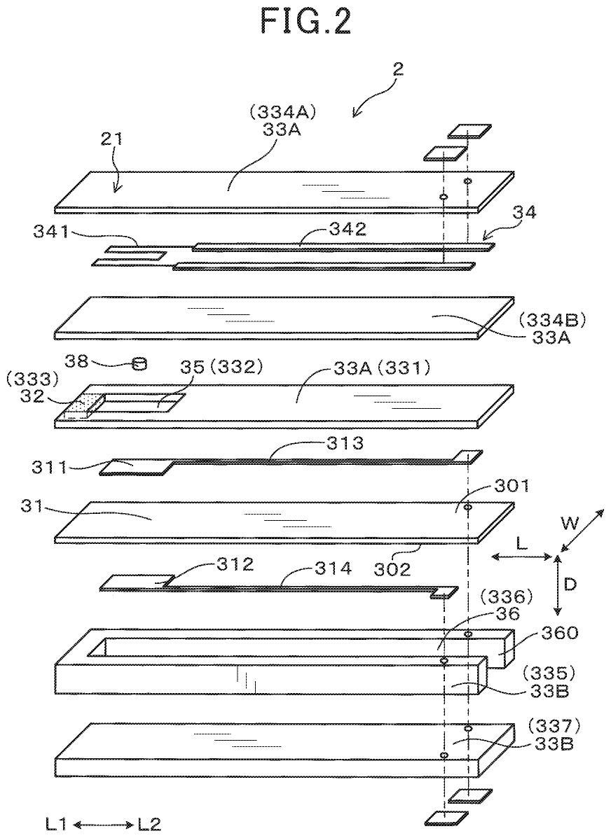

The solid electrolyte body 31 shown in FIGS. 2 to 4 has an oxygen ion (O²⁻) conductivity. The solid electrolyte body 31 has a given length with the first major surface 301 and the second major surface 302 opposed to the first major surface 301 through a thickness thereof. The sensor electrode 311 and the reference electrode 312 are affixed to the first major surface 301 and the second major surface 302 of the solid electrolyte body 31 so that they are opposed to each other through the thickness of the solid electrolyte body 31. The first insulator 33A is stacked above the first major surface 301 of the solid electrolyte body 31, while the second insulator 33B is stacked above the second major surface 302 of the solid electrolyte body 31.

The gas chamber 35 is located close to the first major surface 301 of the solid electrolyte body 31 and formed in the first insulator 33A. The gas chamber 35 has the sensor electrode 311 disposed therein and is defined by a space into which the gas G to be measured (which will also be referred to as measurement gas G) is introduced. The reference gas duct 36 is located close to the second major surface 302 of the solid electrolyte body 31 and formed in the second insulator 33B. The reference gas duct 36 has the reference electrode 312 disposed therein and is defined by a space into which the reference gas A is introduced.

The heater 34 is, as clearly illustrated in FIGS. 2 to 5, embedded in the first insulator 33A which defines the gas chamber 35 therein. The heater 34 includes the heating element 341 and a pair of heater leads 342. The heating element 341 is supplied with electric power to generate heat. The heater leads 342 connect with the heating element 341. The heating element 341 is laid to at least partially overlap the sensor electrode 311 and the reference electrode 312 in the stacking direction D that is a direction in which the solid electrolyte body 31 and the insulators 33A and 33B are stacked (i.e., a thickness-wise direction of a stack of the solid electrolyte body 31 and the insulators 33A and 33B).

The heat transfer member 38 is made of a dense metallic oxide which blocks permeation of the measurement gas G therethrough. The heat transfer member 38 is arranged within a portion of the gas chamber 35 and held between the sensor electrode 311 and the first insulator 33A in which the heater 34 is embedded. The heat transfer member 38 works to facilitate transmission of thermal energy from the heating element 341 to the solid electrolyte body 31, the sensor electrode 311, and the reference electrode 312.

The gas sensor 1 will be described below in more detail.

### Internal Combustion Engine

In use, the gas sensor 1 is installed in an exhaust pipe of an internal combustion engine mounted in a vehicle, such as an automobile, to measure the concentration of oxygen contained in exhaust gas (i.e., the measurement gas G) flowing in the exhaust pipe. The gas sensor 1 may be used as an air-fuel ratio sensor which measures the concentration of oxygen or unburnt gas component contained in the exhaust gas to calculate an air-fuel ratio of mixture delivered to the internal combustion engine. The gas sensor 1 may alternatively be available for various applications other than the air-fuel ratio sensor.

The exhaust pipe usually has a catalyst, for example, a catalytic converter working to reduce harmful emissions in the exhaust gas. The gas sensor 1 may be arranged upstream or downstream of the catalyst in a direction of flow of the exhaust gas in the exhaust pipe. The gas sensor 1 may alternatively be installed in an inlet pipe of a supercharger working to increase the density of air sucked into the internal combustion engine using the exhaust gas. The gas sensor 1 may also be disposed in a pipe of an exhaust gas recirculation (EGR) system through which a portion of the exhaust gas, as emitted from the internal combustion engine into the exhaust gas, is recirculated back to an intake pipe of the internal combustion engine.

The air-fuel ratio sensor which may be used in this embodiment is engineered to measure the air-fuel ratio continuously in a quantitative form in a range of a rich state where a ratio of amount of fuel to amount of air is larger than stoichiometric air-fuel ratio and a lean state where a ratio of amount of fuel to amount of air is smaller than the stoichiometric air-fuel ratio. When the gas sensor 1 is used as the air-fuel ratio sensor, a given level of voltage is applied between the sensor electrode 311 and the reference electrode 312 to exhibit a limiting current characteristic where an electric current is produced as a function of an amount of oxygen ions moving between the sensor electrode 311 to the reference electrode 312 after the measurement gas G is delivered to the gas chamber 35 through the diffusion resistor (i.e., diffusion controller) 32 so that a diffusion rate of the measurement gas G is reduced by the diffusion resistor 32.

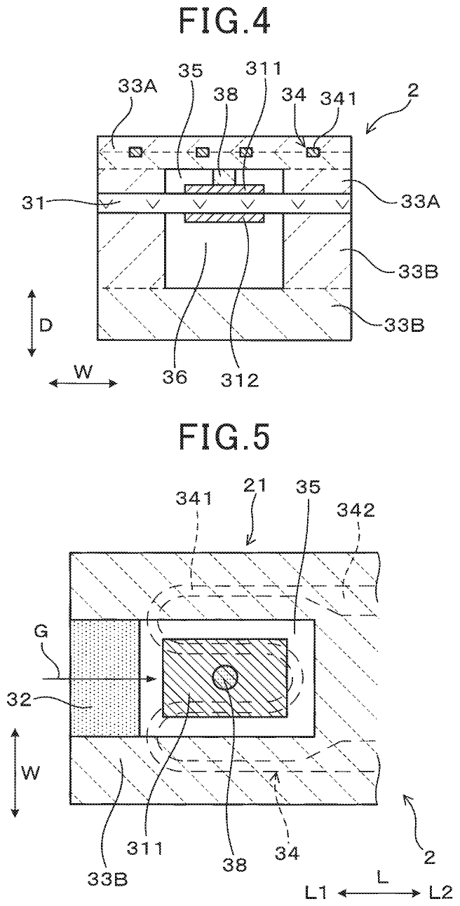

Specifically, as illustrated in FIGS. 3 and 4, when the gas sensor 1 is used as the air-fuel ratio sensor, and an air-fuel ratio on a fuel-lean side is measured, an electric current, as produced when oxygen molecules contained in the measurement gas G are changed into oxygen ions and then moved from the sensor electrode 311 to the reference electrode 312 through the solid electrolyte body 31, is measured. Alternatively, when an air-fuel ratio on a fuel-rich side is measured, an electric current, as produced when oxygen ions are moved from the reference electrode 312 to the sensor electrode 311 through the solid electrolyte body 31 and then react with an unburnt gas component, such as hydrocarbon, carbon monoxide, or hydrogen, contained in the measurement gas G.

### Sensor Device

The sensor device 2 is, as clearly illustrated in FIGS. 3 and 4, made of a stack of the solid electrolyte body 31, the insulators 33A and 33B, and the heater 34 which are laid on the solid electrolyte body 31. The solid electrolyte body 31 is made of zirconia oxide, such as stabilized zirconia or partially stabilized zirconia, which mainly contains 50 mass % or more of zirconia and is formed by substituting a portion of the zirconia with rare-earth metallic elements or alkaline earth elements. The portion of zirconia forming the solid electrolyte body 31 may be substituted with yttria, scandia, or calcia.

The sensor device 2 has a given length with the front end L1 and the rear end L2 which are opposed to, in other words, aligned with each other in the lengthwise direction L. In the following discussion, a front end or a front end portion of each part of the gas sensor 1 which is located on an upstream side of the part in a flow of the measurement gas G, in other words, closest to the front end L1 of the gas sensor 2 will also be referred to as a front end or a front end portion L1 of the part, while a rear end or a rear end portion closest to the rear end L2 of the gas sensor 2 will also be referred to as a rear end, a rear end portion, a base end, or a base end portion L2 of the part. The sensor electrode 311 and the reference electrode 312 are located in the front end portion L1 of the sensor device 2. The sensor electrode 311 is arranged on the first major surface 301 of the solid electrolyte body 31 which is exposed to the measurement gas G. The reference electrode 312 is arranged on the second major surface 302 of the solid electrolyte body 31 which is exposed to the reference gas A.

Each of the sensor electrode 311 and the reference electrode 312 contains platinum that is a noble metal exhibiting a catalytic activity under oxygen and zirconia oxide shared with the solid electrolyte body 31. The shared zirconia oxide is used to ensure a desired degree of mechanical strength of a joint of the sensor electrode 311, the reference electrode 312, and the solid electrolyte body 31 when paste of electrode material is applied or printed on the solid electrolyte body 31 and then fired together.

The gas chamber 35 is surrounded by the first insulator 33A and the solid electrolyte body 31 and located adjacent the first major surface 301 of the solid electrolyte body 31. The gas chamber 35 occupies an area of the first insulator 33A where the sensor electrode 311 is disposed. The reference gas duct 36 is surrounded by the second insulator 33B and the solid electrolyte body 31 and located adjacent the second major surface 302 of the solid electrolyte body 31. The reference gas duct 36 is formed in a portion of the second insulator 33B in which the reference electrode 312 is disposed and which extends toward the rear end (i.e., the right end, as viewed in FIG. 3) of the sensor device 2. The sensor device 2 has the rear end opening 360 which is formed in the rear end L2 thereof (i.e., the rear end of the second insulator 33B) and through which the reference gas A is delivered. The rear end opening 360 communicates with the reference gas duct 36. The first insulator 33A has disposed thereon the diffusion resistor 32 which communicates with the gas chamber 35 and through which the measurement gas G passes and then enters the gas chamber 35 at a given diffusion rate.

The sensor device 2 is, as can be seen in FIGS. 1 and 3, of an elongated planar shape. The sensor electrode 311, the reference electrode 312, the gas chamber 35, the diffusion resistor 32, and the heating element 341 of the heater 34 are arranged in the front end L1 of the length of the sensor device 2. The sensor device 2 also has the sensing portion 21 which is arranged in the front end L1 and includes the sensor electrode 311, the reference electrode 312, and a portion of the solid electrolyte body 31 held between the electrodes 311 and 312.

The lengthwise direction L of the sensor device 2, as referred to herein, is a direction in which the sensor device 2 which is of an elongated shape extends. The stacking direction D, as referred to herein, is a direction which extends perpendicular to the lengthwise direction L and in which the solid electrolyte body 31 and the insulators 33A and 33B are stacked, in other words, a thickness-wise direction of a stack of the solid electrolyte body 31, the insulators 33A and 33B, and the heater 34. A direction perpendicular both to the lengthwise direction L and to the stacking direction D will be referred below to as a width-wise direction W. A portion of the sensor device 2 in which the sensing portion 21 is disposed will also be referred to as the front end side L1, while a portion of the sensor device 2 opposed to the front end side L1 in the lengthwise direction L will also be referred to as the rear end side L2.

The electrode leads 313 and 314 are, as illustrated in FIG. 2, connected to the sensor electrode 311 and the reference electrode 312, respectively, for electrically connecting the electrodes 311 and 312 with an external device arranged outside the gas sensor 1. The electrode leads 313 and 314 extend to the rear end side L2 in the lengthwise direction L. For the sake of clarity, FIGS. 2 and 3 illustrate the dimension of the sensor device 2 in the lengthwise direction L as being shorter than actually.

The heater 34 is, as illustrated in FIGS. 2 and 5, equipped with the heating element 341 which is supplied with electric power to produce heat and the two heater leads 342 connected to rear ends of the heating element 341. The heating element 341 is made of an S-shaped conductive wire with longer straight sections, shorter straight sections, and bends between the longer and shorter straight sections. The longer straight sections of the heating element 341 extend substantially parallel to each other in the lengthwise direction L. Each of the heater leads 342 is made of a straight conductor. The heating element 341 has a resistance value per unit length which is larger than that those of the heater leads 342. Each of the heater leads 342 has a length extending in the lengthwise direction L to have a rear end which coincides with the rear end (i.e., the right end, as viewed in FIG. 2) of the sensor device 2. The heater 34 contains a conductive metallic material.

The heating element 341 extends meanderingly in the lengthwise direction L at the front end side L1 of the heater 34. The heating element 341 may alternatively be shaped to meander in the width-wise direction W. The heating element 341 is located to face or overlap the sensor electrode 311 and the reference electrode 312 in the stacking direction D perpendicular to the lengthwise direction L. When supplied with electric power through the heater leads 342, the heating element 341 produces heat to increase the temperature of the sensor electrode 311, the reference electrode 312, and a portion of the solid electrolyte body 31 disposed between the electrodes 311 and 312 up to a target value (i.e., an activation temperature) at which the sensor device 2 will operate properly.

The heating element 341 has a sectional area smaller than those of the heater leads 342. The heating element 341 has a resistance value per unit length higher than those of the heater leads 342. The sectional area of the heating element 341, as referred to herein, is a transverse sectional area thereof extending perpendicular to the length of the heater leads 342. Similarly, the sectional area of each of the heater leads 342 is a transverse sectional area extending perpendicular to the length of the heater leads 342. When voltage is applied to the heater leads 342, it will cause the heating element 341 to generate heat in the form of Joule heat which increase the temperature of a region around the sensing portion 21.

The first insulator 33A has the gas chamber 35 formed therein and also has the heater 34 embedded therein. The second insulator 33B has the reference gas duct 36 formed therein. The first insulator 33A and the second insulator 33B are made of metallic oxide such as alumina (i.e., aluminum oxide). The insulators 33A and 33B are each formed as a dense body which blocks transmission of the measurement gas G or the reference gas A therethrough. In other words, the insulators 33A and 33B hardly have gas cavities through which gas will pass.

The first insulator 33A, as illustrated in FIGS. 2 and 3, includes the insulating spacer 331 and the investing plates 334A and 334. The insulating spacer 331 has formed therein the hole 332 extending through a thickness thereof in the stacking direction D to define the gas chamber 35. The investing plates 334A and 334B are stacked on the insulating spacer 331 and have the heater 34 embedded therein. Specifically, the heater 34 is interposed between the investing plates 334A and 334B.

The gas chamber 35 is formed by a void space closed by the first insulator 33A, the diffusion resistor 32, and the solid electrolyte body 31. The measurement gas G that is exhaust gas flowing through the exhaust pipe passes through the diffusion resistor 32 and then enters the gas chamber 35.

The diffusion resistor 32 is disposed adjacent the front end L1 of the gas chamber 35 in the lengthwise direction L. Specifically, the diffusion resistor 32 is installed in the inlet opening 333 formed in the front end of the insulating spacer 331 of the first insulator 33A and exposed to the gas chamber 35. The diffusion resistor 32 is made of porous metallic oxide such as alumina. The diffusion velocity (i.e., flow rate) of the measurement gas G flowing into the gas chamber 35 depends upon reduction in velocity of the measurement gas G arising from passage of the measurement gas G through gas cavities of the diffusion resistor 32.

The diffusion resistor 32 may be arranged adjacent to sides of the gas chamber 35 opposed to each other in the width-wise direction W. For instance, the insulating spacer 331 of the first insulator 33A is designed to have two inlet openings 333 formed in sides thereof opposed to each other in the width-wise direction W. Two diffusion resistor 32 are disposed one in each of the inlet openings 333. The diffusion resistor 32 may alternatively be constituted by a pinhole communicating with the gas chamber 35.

The second insulator 33B, as illustrated in FIGS. 2 and 3, includes the insulating spacer 335 and the insulating plate 337. The insulating spacer 335 has formed therein the cut-out (i.e., groove) 336 which defines the reference gas duct 36. The insulating plate 337 is stacked on the insulating spacer 335.

The through-hole 332 and the cut-out 336 may be formed by moulding, cutting, or applying paste to selected areas of the insulating spacer 331 of the first insulator 33A and the insulating spacer 335 of the second insulator 33B in a known way.

The reference gas duct 36 is formed as a duct into which the reference gas A is delivered and has an opening formed in the rear end L2 of the insulating spacer 335. The reference gas duct 36 extends in the lengthwise direction L from the rear end of the sensor device 2 to a portion of the insulating spacer 335 which faces the gas chamber 35 through the solid electrolyte body 31. The reference electrode 312 is disposed in the front end L1 of the reference gas duct 36. The reference gas A (i.e., atmospheric air) is delivered into the reference gas duct 36 from the rear end opening 360 located at the rear end of the sensor device 2.

The reference gas duct 36 is shaped to have a transverse sectional area, expanding perpendicular to the lengthwise direction L, which is larger than that of the gas chamber 35 extending perpendicular to the lengthwise direction L. The dimension (i.e., the width) of the reference gas duct 36 in the stacking direction D is larger than that of the gas chamber 35 in the stacking direction D. The reference gas duct 36 is larger in transverse sectional area, width, and volume than the gas chamber 35, thereby ensuring a sufficient amount of oxygen in the reference gas A delivered from the reference gas duct 36 to the sensor electrode 311 for reaction with unburnt gas on the sensor electrode 311.

Referring back to FIG. 1, the porous layer 37 covers an entire circumference of the front end L1 of a length of the sensor device 2. The porous layer 37 serves to trap therein toxic substances to which the sensor electrode 311 is exposed or condensed water produced in the exhaust gas. The porous layer 37 is made of porous metallic oxide such as alumina. The porosity of the porous layer 37 is larger than that of the diffusion resistor 32, so that the flow rate of the measurement gas G passing through the porous layer 37 is larger than that of the measurement gas G passing through the diffusion resistor 32.

### Heat Transfer Member

The heat transfer member 38 is, as clearly illustrated in FIGS. 3 and 4, interposed between the sensor electrode 311 and the first insulator 33A in contact with a portion of the sensor electrode 311.

The heat transfer member 38 is shaped to have a transverse sectional area, as extending in a direction perpendicular to the stacking direction D of the sensor device 2, which is smaller than that of the sensor electrode 311. The heat transfer member 38 is of a cylindrical shape and arranged on or near the center of the major surface of the sensor electrode 311 (i.e., the center of a cross section of the sensor electrode 311 extending perpendicular to the stacking direction D) between the major surface of the sensor electrode 311 and an inner surface of the first insulator 33A. The heat transfer member 38 is shaped to have a circular transverse section, but may alternatively be designed in another shape.

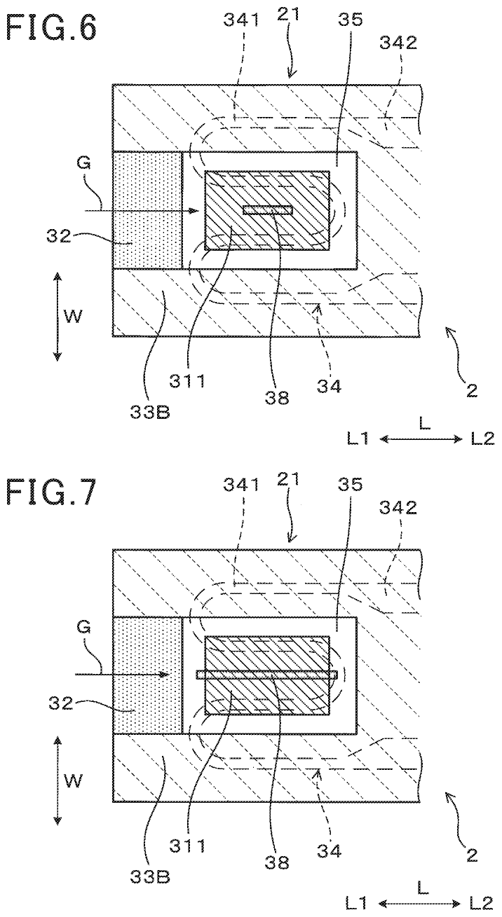

For instance, the heat transfer member 38 may be, as illustrated in FIG. 6, formed in a rectangular shape in cross section and arranged on or near the center of the sensor electrode 311. The heat transfer member 38 may also be, as illustrated in FIG. 7, shaped to have a transverse section extending over the sensor electrode 311 in the lengthwise direction L so as to have ends located outside the sensor electrode 311, in other words, facing the first major surface 301 of the solid electrolyte body 31. The heat transfer member 38 may alternatively be shaped to extend continuously from one end to the other end of the sensor electrode 311 in the lengthwise direction L. The heat transfer member 38 which is rectangular may be elongated to have a length extending in the lengthwise direction L or the width-wise direction W. The heat transfer member 38 may be shaped to have two sections: one extending in the lengthwise direction L, and the other extending in the width-wise direction W. The sensor device 2 may be equipped with a plurality of heat transfer members 38 arranged at different locations between the sensor electrode 311 and the first insulator 33A.

The degree of heat transfer achieved by the heat transfer member 38 may be enhanced by increasing a transverse sectional area of the transfer member 38 extending perpendicular to the stacking direction D. In a case where the heat transfer member 38 is placed in direct contact with the sensor electrode 311, an increase in area of contact between the heat transfer member 38 and the sensor electrode 311 will result in an increase in surface area of the sensor electrode 311 exposed to the measurement gas G. It is, therefore, advisable that the transverse sectional area of the heat transfer member 38 be selected in view of a balance between transfer of heat from the heating element 341 to the solid electrolyte body 31 and electrochemical reaction created on the sensor electrode 311.

The heat transfer member 38 may be made by applying paste of metallic oxide to the first insulator 33A or the sensor electrode 311 and then sintering the whole of the sensor device 2. The formation of the heat transfer member 38 may alternatively be achieved by placing a solid spacer, as used in making the heat transfer member 38, between the first insulator 33A and the sensor electrode 311 and then sintering the whole of the sensor device 2.

The heat conduction of the heat transfer member 38 is usually enhanced by selecting the heat conductivity (i.e., heat transfer rate) of noble metal contained in the sensor electrode 311 to be higher than that of metallic oxide contained in the sensor electrode on an interface between the heat transfer member 38 and the sensor electrode 311, while it will be decreased on an interface between the heat transfer member 38 and the first insulator 33A, but however, it results in firm joint of metallic oxides.

The heat transfer member 38 may be made of an insulating metallic oxide, such as alumina, zirconia, aluminum nitride, or silicon carbide. The heat transfer member 38 is made to be dense so that it almost blocks passage of gas therethrough. Specifically, in the heat transfer member 38, particles of metallic oxide are sintered together, so that there are almost no gaps between the particles, thereby blocking passage of the measurement gas G (i.e., exhaust gas) therethrough. The heat transfer member 38 hardly has voids therein, thereby resulting in enhanced heat conductivity thereof.

### Other Arrangements of Gas Sensor

The gas sensor 1, as clearly illustrated in FIG. 1, also includes the first insulator 42 retaining the sensor device 2, the housing 41 retaining the first insulator 42, the second insulator 43 coupled with the first insulator 42, and the contact terminals 44 which are retained by the second insulator 43 in contact with the sensor device 2. The gas sensor 1 is also equipped with the front cover 45, the rear cover 46, and the bush 47. The front cover 45 is fit in the front end L1 of the housing 41. The rear cover 46 is fit on the rear end L2 of the housing 41 and shrouds the second insulator 43 and the contact terminals 44. The bush 47 retains the leads 48 within the rear cover 46. The leads 48 connect with the contact terminals 44.

In use, the front cover 45 is disposed inside the exhaust pipe of the internal combustion engine. The front cover 45 has formed therein gas inlets 451 through which the measurement gas G passes. The front cover 45 has a double-walled structure, but may alternatively be designed to have a single-walled structure. The measurement gas G (i.e., exhaust gas) enters the front cover 45 through the gas inlets 451 of the front cover 45 and then is delivered to the sensor electrode 311 through the porous layer 37 and the diffusion resistor 32 of the sensor device 2.

The rear cover 46 shown in FIG. 1 is arranged outside the exhaust pipe of the internal combustion engine. The rear cover 46 has formed therein the air inlets 461 through which the reference gas A (i.e., atmospheric air) is introduced into the rear cover 46. The filter 462 is disposed over the air inlets 461. The filter 462 allows gas to pass therethrough, but blocks passage of liquid therethrough. The reference gas A enters inside the rear cover 46 through the air inlets 461 and then is delivered to the reference electrode 312 through a clearance inside the rear cover 46 and the reference gas duct 36.

The contact terminals 44 are, as illustrated in FIGS. 1 and 2, disposed inside the second insulator 43 and respectively connected to the electrode lead 313 of the sensor electrode 311, the electrode lead 314 of the reference electrode 312, and the heater leads 342 of the heater 34. Each of the leads 48 is connected to one of the contact terminals 44.

The leads 48 of the gas sensor 1 are, as illustrated in FIGS. 1 and 3, connected to the sensor controller 6 working to analyze an output from the gas sensor 1 to determine the concentration of the measurement gas G. Specifically, the sensor controller 6 works to electrically control an operation of the gas sensor 1 in cooperation with an engine controller serving to control a combustion operation of the internal combustion engine. The sensor controller 6 has the current measuring circuit 61, the voltage applying circuit 62, and a heater energizing circuit installed therein. The current measuring circuit 61 measures an electric current flowing between the sensor electrode 311 and the reference electrode 312. The voltage applying circuit 62 applies voltage between the sensor electrode 311 and the reference electrode 312. The heater energizing circuit works to electrically energize the heater 34. The sensor controller 6 may be constructed in the engine controller.

### Production Method

In a production method of the sensor device 2, the solid electrolyte body 31, the insulators 33A and 33B, the diffusion resistor 32, and the heater 34 are first placed on each other to make a stack body. The stack body is then heated and sintered. The sensor electrode 311 and the reference electrode 312 is made by applying paste containing platinum, solid electrolyte, and solvent on the solid electrolyte body 31 using a printing technique and then sintering the platinum and the solid electrolyte of the paste concurrently with the sintering of the stack body.

### BENEFICIAL ADVANTAGE

The gas sensor 1 has the heater 34 embedded in the first insulator 33A which defines the gas chamber 35. The gas sensor 1 also has the heat transfer member 38 retained between the sensor electrode 311 and the first insulator 33A within a portion of the gas chamber 35. The heat transfer member 38 is made of a dense metallic oxide material which blocks passage of the measurement gas G therethrough and serves to facilitate transfer of heat from the heating element 341 of the heater 34 to the solid electrolyte body 31 and the electrodes 311 and 312.

In use of the gas sensor 1, when the heating element 341 is energized to heat the solid electrolyte body 31 and the electrodes 311 and 312, thermal energy or heat, as generated by the heating element 341, is transmitted to the solid electrolyte body 31 and the electrodes 311 and 312 through the first insulator 33A and also transferred to the solid electrolyte body 31 and the electrodes 311 and 312 through the heat transfer member 38. In other words, the heat propagates through two thermal paths: one extending from the heating element 341 to the solid electrolyte body 31 and the electrodes 311 and 312, bypassing the gas chamber 35, and the second extending from the heating element 341 directly to the solid electrolyte body 31 and the electrodes 311 and 312 through the heat transfer member 38.

The use of the heat transfer member 38, therefore, serves to enhance the thermal conductivity from the heating element 341 to the solid electrolyte body 31 and the electrodes 311 and 312, in other words, the heat-transfer performance of the sensor device 2. This also results in a shortened period of time required by the heating element 341 to heat the sensor device 2 up to a temperature at which the sensor device 2 is activated to achieve a required degree of conductivity of oxygen ions therein in use of the gas sensor 1.

The use of the heat transfer member 38 also enhances efficiency in delivering thermal energy, as generated by the heating element 341, to the solid electrolyte body 31 and the electrodes 311 and 312 in use of the gas sensor 1. This also results in a decrease in electric power consumed by the heater 34 to heat the sensor device 2.

The heater 34 is, as described above, embedded in the first insulator 33A which forms the gas chamber 35, thereby resulting in a decrease in distance between the heater 34 and the solid electrolyte body 31, which will lead to a shortened period of time required by the heating element 341 of the heater 34 to heat the solid electrolyte body 31 and the electrodes 311 and 312 to a required temperature.

The structure of the gas sensor 1, therefore, enhances the heat transfer performance of the sensor device 2 to achieve quick activation of the sensor device 2.

### Second Embodiment

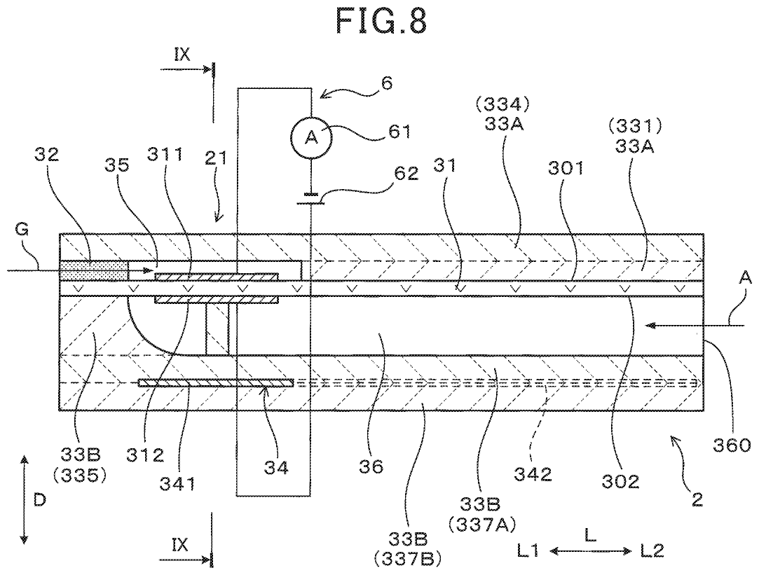

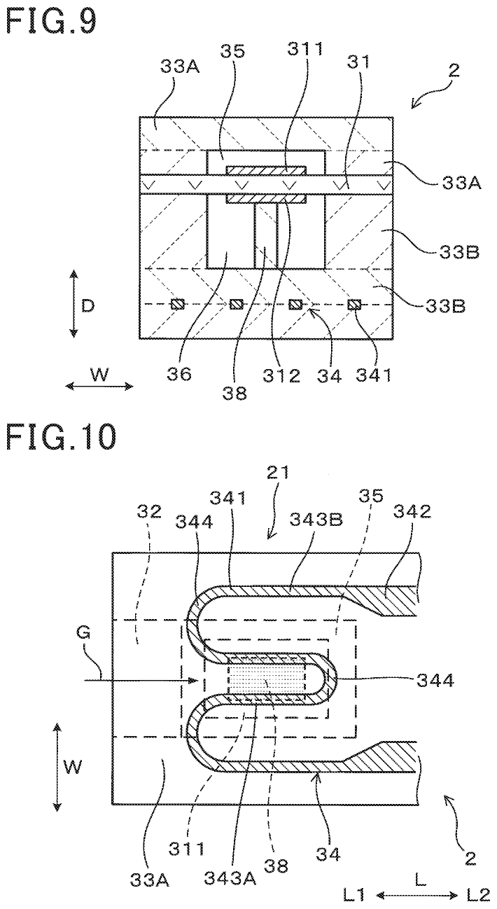

FIGS. 8 and 9 illustrate the sensor device 2 according to the second embodiment which has the heater 34 embedded in the second insulator 33B.

The second insulator 33B has formed therein the reference gas duct 36 into which the reference gas A is delivered. The heater 34 is oriented to face the reference electrode 312 in the second insulator 33B in the stacking direction D. The heat transfer member 38 is held by the reference electrode 312 and the second insulator 33B in which the heater 34 is embedded and arranged in a portion of the reference gas duct 36.

The second insulator 33B is made of a stack of the insulating spacer 335 in which the reference gas duct 36 is formed and the insulating plates 337A and 337B in which the heater 34 is embedded. The first insulator 33A is made of a stack of the insulating spacer 331 and the insulating plate 334 and has the gas chamber 35 formed therein.

The sensor device 2 in this embodiment, like in the first embodiment, has an enhanced ability to transfer heat, as generated by the heating element 341 of the heater 34, to the solid electrolyte body 31 and the electrodes 311 and 312 through the second insulator 33B and the heat transfer member 38.

The structure of the gas sensor 1 in the second embodiment, therefore, enhances the heat transfer performance of the sensor device 2 to achieve quick activation of the sensor device 2.

Other arrangements of the gas sensor 1 and beneficial advantages offered by the gas sensor 1 are identical with those in the first embodiment. In FIGS. 8 and 9, the same reference numbers as employed in the first embodiment refer to the same or similar parts, and explanation thereof in detail is omitted.

### Third Embodiment

FIGS. 10 to 22 illustrate a plurality of types of the sensor device 2 according to the third embodiment which are different in layout of the heating element 341 of the heater 34 and the heater transfer member 38. Throughout the drawings, the same reference numbers will refer to the same or similar parts, and explanation thereof in detail will be omitted.

In FIG. 10, a portion of the heating element 341 and a portion of the heat transfer member 38 are laid to overlap each other in the stacking direction D (i.e., the thickness-wise direction of the sensor device 2). The heater 34 is embedded in the first insulator 33A. The heating element 341 is designed or oriented to have the thermal center which is located on a plane defined to extend through the heating element 341 in a direction perpendicular to the stacking direction D (i.e., a plane extending parallel to the lengthwise direction L and the width-wise direction W) and which has the highest temperature on the plane.

The thermal center is located on or near the center of an area in the first insulator 33A where the heating element 341 is arranged in the lengthwise direction L and the width-wise direction W.

The thermal center forms a heat spot on which heat is concentrated one minute after the heater 34 starts to be energized. The location of the heat spot depends upon the geometrical configuration of the heating element 341 and an overlap of the heat transfer member 38 with the heating element 341 in the stacking direction D. In this embodiment, the heat spot is developed on the center of a plane (i.e., a flat surface) of the sensor electrode 311.

The heating element 341, as can be seen in FIG. 10, is curved in a meandering form (i.e., S-shape) in the lengthwise direction L. Specifically, the heating element 341 includes a plurality of straight sections 343A and 343B extending parallel to each other in the lengthwise direction L and a plurality of curved joint sections 344 each connecting between an adjacent two of the straight sections 343A and 343B. Specifically, the parallel straight sections 343A include two inner straight sections, while the parallel straight sections 343B include two outer straight sections located outside the inner straight sections 343A in the width-wise direction W.

A minimum interval between the inner straight sections 343A in the width-wise direction W is shorter than that between each of the inner straight sections 343A and an adjacent one of the outer straight sections 343B. The heat transfer member 38 is shaped to have a portion overlapping portions of the inner straight sections 343A in the stacking direction D. The layout where the interval between the inner straight sections 343A is less than that between each of the inner straight sections 343A and an adjacent one of the outer straight sections 343B in the width-wise direction W facilitates the ease with which the heat transfer member 38 is arranged to have a portion facing portions of the inner straight sections 343A in the stacking direction D.

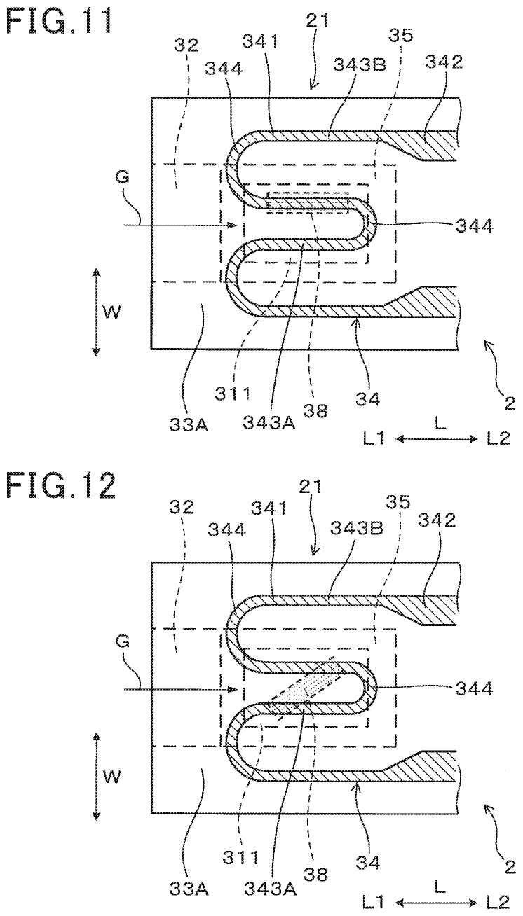

The heat transfer member 38 is located on a plane extending parallel to the lengthwise direction L and the width-wise direction W and has a length extending in the lengthwise direction L. The heat transfer member 38 is oriented to have a portion overlapping portions of the inner straight sections 343A in the stacking direction D. The heat transfer member 38 may be, as illustrated in FIG. 11, elongated to face one of the inner straight sections 343A in the stacking direction D.

The heat transfer member 38 may alternatively be, as illustrated in FIG. 12, shaped to have a length obliquely extending at a given angle other than 0° and 90° to the lengthwise direction L on a plane extending parallel to the lengthwise direction L and the width-wise direction W. The heat transfer member 38 has portions facing or overlapping portions of the inner straight sections 343A in the stacking direction D.

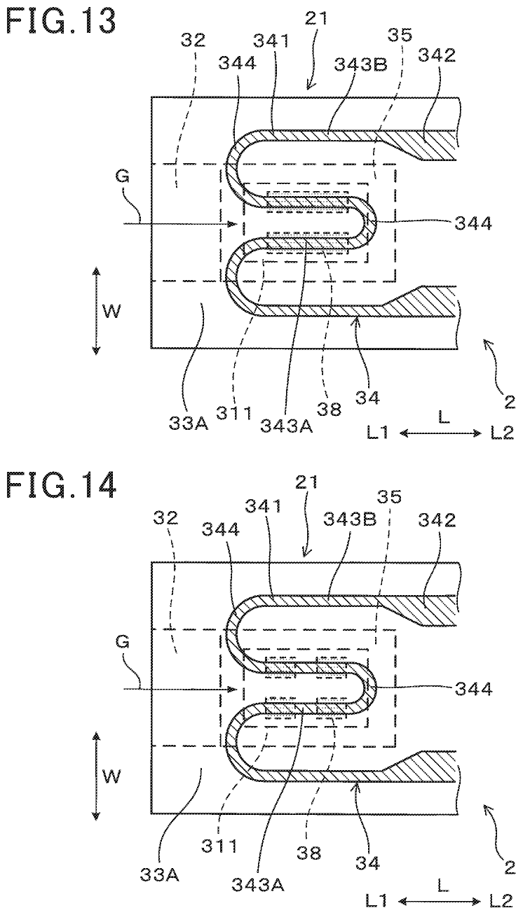

The heat transfer member 38 may also be, as illustrated in FIG. 13, designed to have two discrete portions each of which overlaps one of the inner straight sections 343A of the heater 34 in the stacking direction D. The discrete portions of the heat transfer member 38 extend parallel to the inner straight sections 343A.

The heat transfer member 38 may alternatively be, as illustrated in FIG. 14, designed to have four discrete portions which are located away from each other in the lengthwise direction L and the width-wise direction W and overlap different portions of the inner straight sections 343A in the stacking direction D.

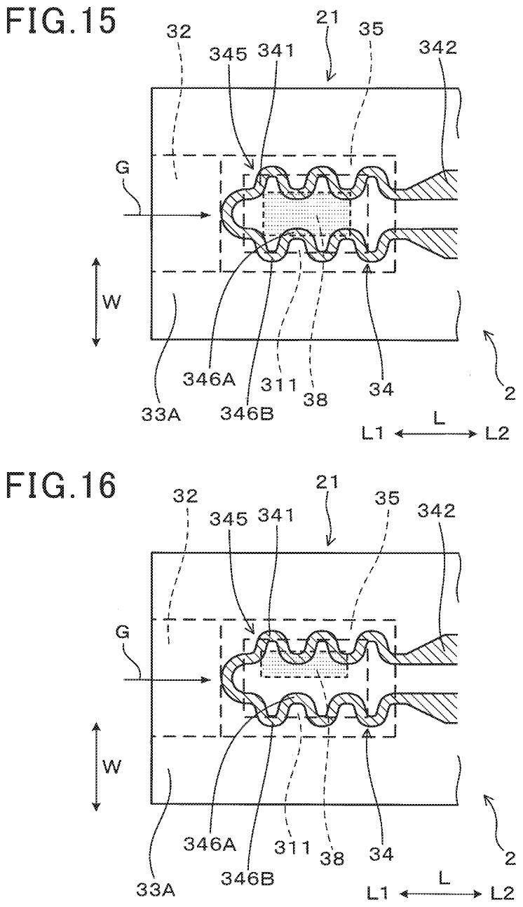

The heating element 341 of the heater 34 may be, as illustrated in FIG. 15, waved in the lengthwise direction L, in other words, meander in the width-wise direction W. Specifically, the heating element 341 includes two meandering or waved sections 345 which extend in the lengthwise direction L and connect with the respective heater leads 342. Each of the waved sections 345 includes inner curved sections 346A and outer curved sections 346B located outside the inner curved sections 346A in the width-wise direction W.

The heat transfer member 38 is located to overlap the inner curved sections 346A of each of the waved sections 345 of the heater 34 in the stacking direction D.

The heat transfer member 38 may alternatively be, as illustrated in FIG. 16, designed to overlap the inner curved sections 346A of one of the waved sections 345 in the stacking direction D. The heat transfer member 38 may be oriented to have a length extending parallel to the lengthwise direction L of the sensor device 2.

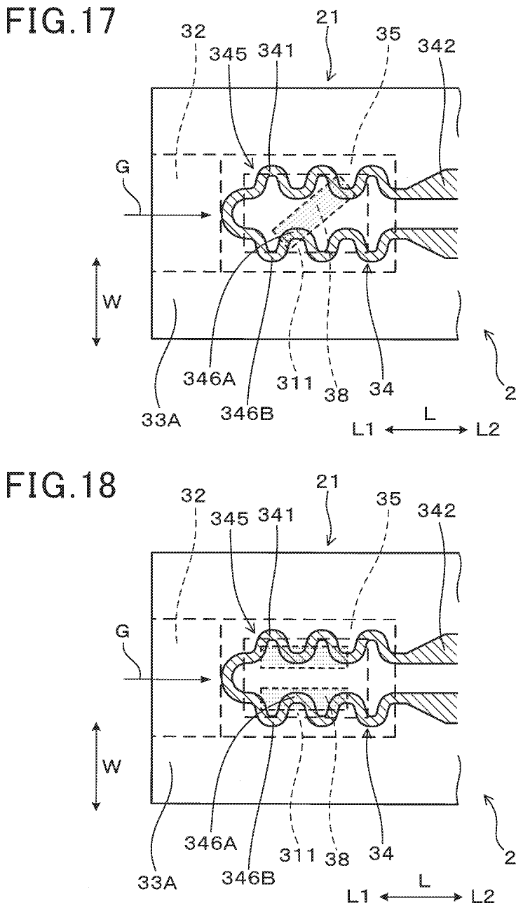

The heat transfer member 38 may alternatively be, as illustrated in FIG. 17, oriented to have a length obliquely extending at a given angle other than 0° and 90° to the lengthwise direction L on a plane extending parallel to the lengthwise direction L and the width-wise direction W. Specifically, the heat transfer member 38 has portions overlapping portions of the waved portions 345 in the stacking direction D.

The heat transfer member 38 may be, as illustrated in FIG. 18, designed to have two discrete portions each of which overlaps one of the waved sections 345 of the heater 34 in the stacking direction D. Each of the discrete portions of the heat transfer member 38 may be disposed to overlap the inner curved sections 346A of one of the waved sections 345 in the stacking direction D. Alternatively, each of the discrete portions of the heat transfer member 38 may be disposed to overlap both the inner curved sections 346A and the outer curved sections 346B of one of the waved sections 345 in the stacking direction D.

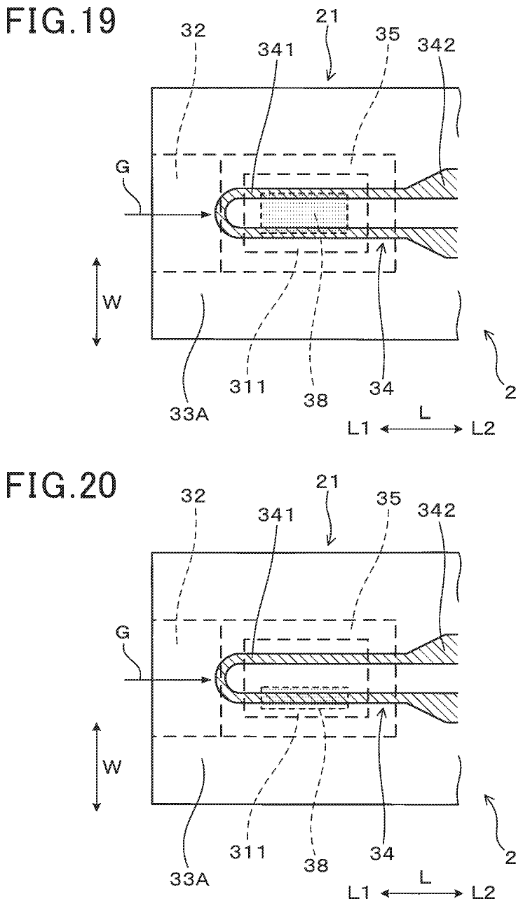

The heating element 341 of the heater 34 is not necessarily required to be curved as long as the heating element 341 has an electric resistance value higher than those of the heater leads 342. The heating element 341 may be, as illustrated in FIG. 19, shaped to extend straight to connect with the respectively the heater leads 342. Specifically, the heating element 341 is made up of a pair of straight sections extending parallel to each other in the lengthwise direction L of the sensor device 2 and a C-shaped section connecting the straight sections together. The heating element 341 is of a U-shape as a whole. The heat transfer member 38 is laid to overlap the straight sections of the heating element 341 in the stacking direction D. The heat transfer member 38 may alternatively be, as illustrated in FIG. 20, arranged to overlap only one of the straight sections of the heating element 341 in the stacking direction D.

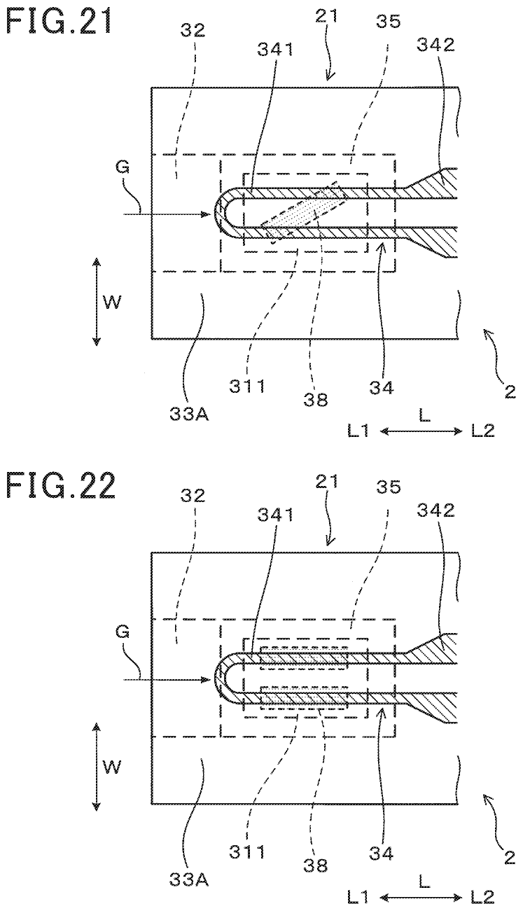

The heat transfer member 38 may alternatively be, as illustrated in FIG. 21, oriented to have a length obliquely extending at a given angle other than 0° and 90° to the lengthwise direction L. Specifically, the heat transfer member 38 is inclined to have portions overlapping portions of the straight sections of the heating element 341 in the stacking direction D. The heat transfer member 38 may be, as illustrated in FIG. 22, designed to have two discrete straight sections each of which overlaps one of the parallel straight sections of the heating element 341 in the stacking direction D.

The heater 34 in the third embodiment may alternatively be designed to have the heater 34 embedded in the second insulator 33B instead of the first insulator 33A. In this case, the heating element 341 and the heat transfer member 38 may be positioned relative to each other in a selected one of the layouts shown in FIGS. 10 to 22.

Other arrangements of the gas sensor 1 and beneficial advantages offered by the gas sensor 1 are identical with those in the first embodiment. In FIGS. 10 to 22, the same reference numbers as employed in the first embodiment refer to the same or similar parts, and explanation thereof in detail is omitted.

### Fourth Embodiment

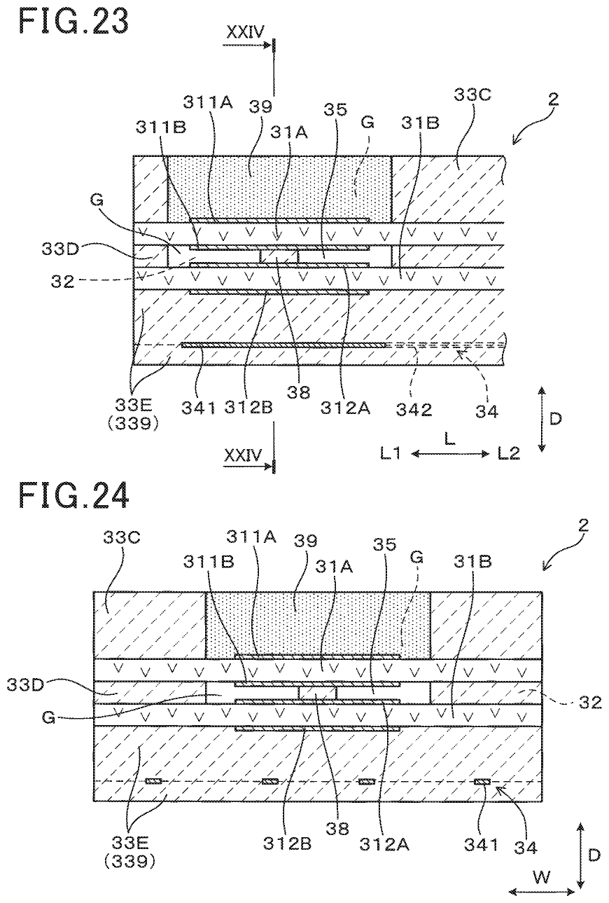

The sensor device 2 in the fourth embodiment is, as illustrated in FIGS. 23 and 24, equipped with a plurality of solid electrolyte bodies 31A and 31B.

Specifically, the sensor device 2 has two solid electrolyte bodies 31A and 31B and the gas chamber 35 defined between the solid electrolyte bodies 31A and 31B. The heat transfer member 38 is disposed in a portion of the gas chamber 35. The solid electrolyte body 31A will also be referred to as a first solid electrolyte body 31A equipped with the first pump electrode 311A and the second pump electrode 311B. The solid electrolyte body 31B will also be referred to as a second solid electrolyte body 31B equipped with the sensor electrode 312A and the reference electrode 312B.

The first solid electrolyte body 31A has oxygen ion conductivity. The first solid electrolyte body 31A is located farther away from the third insulator 33E in which the heater 34 is embedded than the second solid electrolyte body 31B is. The first pump electrode 311A and the second pump electrode 311B are disposed on opposed major surfaces of the front end portion L1 of a length of the first solid electrolyte body 31A. The first pump electrode 311A and the second pump electrode 311B face each other through a thickness of the first solid electrolyte body 31A. The second solid electrolyte body 31B is located to face the first solid electrolyte body 31A in the stacking direction D and has oxygen ion conductivity. The sensor electrode 312A and the reference electrode 312B are disposed on opposed major surfaces of the front end portion L1 of a length of the second solid electrolyte body 31B. The sensor electrode 312A and the reference electrode 312B face each other through a thickness of the second solid electrolyte body 31B.

The sensor device 2 also includes the first insulator 33C, the second insulator 33D which defines the gas chamber 35, and the third insulator 33E in which the heater 34 is embedded. The first insulator 33C is stacked on the major surface of the first solid electrolyte body 31A on which the first pump electrode 311A is arranged. The first insulator 33C has disposed therein the porous member 39 which serves to protect the first pump electrode 311A and through which the measurement gas G is delivered to the first pump electrode 311A.

The second insulator 33D is, as clearly illustrated in FIGS. 23 and 24, held between the major surface of the first solid electrolyte body 31A on which the second pump electrode 311B is mounted and the major surface of the second solid electrolyte body 31B on which the sensor electrode 312A is mounted. The second insulator 33D has the diffusion resistors 32 which are disposed on side portions of thereof opposed to each other in the width-wise direction W and through which the measurement gas G passes. The diffusion resistor 32 may alternatively be arranged in the front end L1 of a length of the second insulator 33D. The major surface of the first solid electrolyte body 31A on which the second pump electrode 311B is disposed directly faces the major surface of the second solid electrolyte body 31B on which the sensor electrode 312A is disposed.

The third insulator 33E is stacked on the major surface of the second solid electrolyte body 31B to which the reference electrode 312B is affixed. The third insulator 33E includes two insulating plates 339 which retains the heater 34 therebetween. The reference electrode 312B is held between the second solid electrolyte body 31B and the third insulator 33E and embedded in the third insulator 33E.

The first pump electrode 311A and the second pump electrode 311B are placed on the opposed major surfaces of the first solid electrolyte body 31A and face each other in the stacking direction D. The second pump electrode 311B and the sensor electrode 312A directly face each other in the gas chamber 35.

The heater 34 is embedded in the third insulator 33E and includes the heating element 341 which is supplied with electric power to generate heat and the heater leads 342 connecting with the rear ends L2 of the heating element 341. The heating element 341 is disposed to at least a portion overlapping the electrodes 311A, 311B, 312A, and 312B in the stacking direction D (i.e., a thickness-wise direction) of a stack of the solid electrolyte bodies 31A and 31B and the insulators 33C, 33D, and 33E.

The gas chamber 35 is enclosed by the first solid electrolyte body 31A, the second solid electrolyte body 31B, and the second insulator 33D and has the second pump electrode 311B and the sensor electrode 312A disposed therein. The diffusion resistors 32 communicate with the gas chamber 35 and are disposed in the second insulator 33D. The diffusion resistors 32 work to deliver the measurement gas G into the gas chamber 35 at a given diffusion rate.

The heat transfer member 38 is, as illustrated in FIGS. 23 and 24, held between the second pump electrode 311B and the sensor electrode 312A in a portion of the gas chamber 35. The heat transfer member 38 works to facilitate transfer of heat from the heating element 341 to the first solid electrolyte body 31A, the first pump electrode 311A, and the second pump electrode 311B. The sensor device 2 may be equipped with a plurality of heat transfer members 38 arranged at different locations within the gas chamber 35. The heat transfer member 38 may be, like in the third embodiment, arranged to overlap the heating element 341 in the stacking direction D.

In use of the gas sensor 1 equipped with the sensor device 2 in this embodiment, voltage is applied between the first pump electrode 311A and the second pump electrode 311B to regulate the concentration of oxygen contained in the measurement gas G flowing into the gas chamber 35. Voltage is also applied between the sensor electrode 312A and the reference electrode 312B to exhibit a limiting current characteristic therebetween by means of the diffusion resistors 32. This produces a flow of sensor current between the sensor electrode 312A and the reference electrode 312B as a function of a concentration of oxygen within the gas chamber 35. The sensor controller 6 for the gas sensor 1 analyzes the sensor current to determine an air-fuel ratio in the internal combustion engine using the concentration of oxygen in the measurement gas G.

Heat, as produced by the heating element 341, is transmitted to the first solid electrolyte body 31A and the first and second pump electrodes 311A and 311B through the third insulator 33E and the second solid electrolyte body 31B and also through the second insulator 33D disposed around the gas chamber 35. Additionally, the heat transfer member 38 serves to transfer the heat, as generated by the heating element 341, from the second electrode 312A of the second solid electrolyte body 31B directly to the second pump electrode 311B of the first solid electrolyte body 31A. The heat, as produced by the heating element 341, is transmitted to the first solid electrolyte body 31A not only through the second insulator 33D around the electrodes 311A, 311B, 312A, and 312B, but also through the electrodes 311A, 311B, 312A, and 312B and the heat transfer member 38.

As apparent from the above discussion, the gas sensor 1 in this embodiment has an enhanced ability to transfer the heat from the heating element 341 to the first solid electrolyte body 31A, the first pump electrode 311A, and the second pump electrode 311B.

Therefore, the gas sensor 1 in this embodiment, like in the first embodiment, enhances the heat transfer performance of the sensor device 2 to achieve quick activation of the sensor device 2.

Other arrangements of the gas sensor 1 and beneficial advantages offered by the gas sensor 1 are identical with those in the first embodiment. In FIGS. 23 and 24, the same reference numbers as employed in the first embodiment refer to the same or similar parts, and explanation thereof in detail is omitted.

### Fifth Embodiment

The sensor device 2 in the fifth embodiment is a modification of the first embodiment which is designed to have the heat transfer member 38 retained among the first insulator 33A, the sensor electrode 311, and the solid electrolyte body 31.

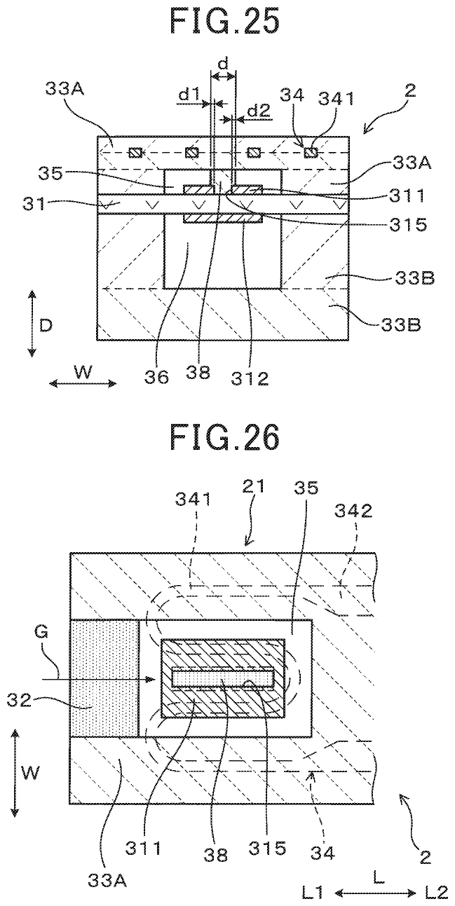

The heat transfer member 38 is, as clearly illustrated in FIGS. 25 and 26, disposed in the sensor electrode 311 in contact with the surface of the solid electrolyte body 31. Specifically, the sensor electrode 311 has formed therein the through-hole 315 passing through the thickness of the sensor electrode 311 in the stacking direction D. The through-hole 315 is located in the center of the sensor electrode 311 and shaped as a rectangular groove which has a length extending in the lengthwise direction L of the sensor electrode 311. The heat transfer member 38 is placed in contact with a portion of the sensor electrode 311 and a portion of the solid electrolyte body 31.

The heat transfer member 38 is arranged in contact with the solid electrolyte body 31 through the through-hole 315 and also in contact with the inner wall of the sensor electrode 311 which defines the through-hole 315. In other words, the heat transfer member 38 continuously overlaps the surfaces of the solid electrolyte body 31 and the sensor electrode 311. The heat transfer member 38 is shaped to be rectangular and contoured to conform with the rectangular configuration of the through-hole 315.

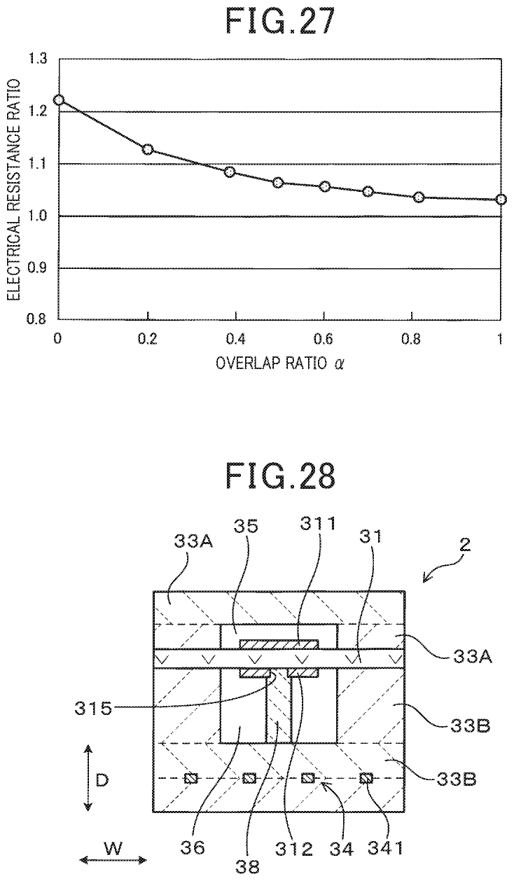

FIG. 27 shows a ratio a of an overlap of the heat transfer member 38 with the sensor electrode 311 to a region, as defined to extend in the width-wise direction W, where the heat transfer member 38 contacts the solid electrolyte body 31 and the sensor electrode 311 on a transverse section of the sensor device 2 in a direction perpendicular to the lengthwise direction L. Specifically, the overlap ratio a, as referred to therein, is given by a relation of a=(d1+d2)/d where d is a width of the heat transfer member 38 in the width-wise direction W, and d1 and d2 are distances of overlaps of the heat transfer member 38 with portions of the sensor electrode 311 in the width-wise direction W.

The graph of FIG. 27 represents a change in a ratio of electrical resistance of the sensor electrode 311 with a change in the overlap ratio a between 0 and 1. The ratio of the electrical resistance of the sensor electrode 311, as referred to herein, is a ratio of an electrical resistance of the sensor electrode 311 to a reference electrical resistance of the sensor electrode 311 that is one in the absence of the heat transfer member 38 in the sensor device 2. Accordingly, when the overlap ratio a is one, it means that the whole of the heat transfer member 38 is in direct contact with the sensor electrode 311. The overlap ratio a is decreased by increasing the size of the through-hole 315 formed in a portion of the sensor electrode 311 which coincides with the heat transfer member 38. When the overlap ratio a is zero, it means that the whole of the heat transfer member 38 is arranged in the through-hole 315 in contact with the solid electrolyte body 31. A decrease in overlap ratio a means a decrease in area of the sensor electrode 311, which results in an increase in ratio of the electrical resistance of the sensor electrode 311.

The electrical resistance of the sensor electrode 311 is a resistance of the sensor electrode 311 to a flow of electrical current produced by oxygen ions moving between the sensor electrode 311 and the reference electrode 312 through the solid electrolyte body 31. The electrical resistance of the sensor electrode 311 in the graph of FIG. 27 is an electrical resistance when the sensor electrode 311 is at 750°. The graph shows that a rate of increase in electrical resistance of the sensor electrode 311 becomes great when the overlap ratio a is decreased below 0.4. It is, thus, advisable that the overlap ratio a be selected to be higher than or equal to 0.4.

The heat transfer member 38 in this embodiment is placed in continuous contact with both the sensor electrode 311 and the solid electrolyte body 31, thereby resulting in an increase in mechanical strength of joint of the heat transfer member 38 to the sensor device 2 without undesirably decreasing an effective surface area of the sensor electrode 311. More specifically, the heat transfer member 38 is arranged in contact not only with the sensor electrode 311, but also with the solid electrolyte body 31, which results in a decrease in area of the sensor electrode 311 covered with the heat transfer member 38, which provides a required effective surface area of the sensor electrode 311. This ensures the stability in operation of the gas sensor 1 to measure the measurement gas G without undesirably increasing the electrical resistance of the sensor electrode 311.

The heat transfer member 38 is joined both to the sensor electrode 311 and to the solid electrolyte body 31. The first joint of the heat transfer member 38 and the solid electrolyte body 31 is achieved by a joint between metallic oxides thereof. This results in an increase in mechanical securement of the heat transfer member 38 in the sensor device 2. The use of the heat transfer member 38, like in the above embodiments, enhances the heat transfer performance of the sensor device 2.

The sensor electrode 311 may alternatively be designed to have a cut-out machined therein instead of the through-hole 315. The cut-out is, like the through-hole 315, formed by removing a portion of the sensor electrode 311 so as to expose the surface of the solid electrolyte body 31 outside the sensor electrode 311.

Other arrangements of the gas sensor 1 and beneficial advantages offered by the gas sensor 1 are identical with those in the first embodiment. In FIGS. 25 and 26, the same reference numbers as employed in the first embodiment refer to the same or similar parts, and explanation thereof in detail is omitted.

### Sixth Embodiment

FIG. 28 illustrates the sensor device 2 according to the sixth embodiment that is a modification of the second embodiment. Specifically, the heat transfer member 38 is retained by or among the second insulator 33B, the reference electrode 312, and the solid electrolyte body 31.

The heater 34 is embedded in the second insulator 33B in which the reference gas duct 36 is formed. The heat transfer member 38 is placed in continuous contact with the reference electrode 312 and the solid electrolyte body 31. The reference electrode 312 has formed therein the through-hole 315 extending the thickness of the reference electrode 312 in the stacking direction D. The through-hole 315 is located in the center of the reference electrode 312 and shaped as, for example, a rectangular groove which has a length extending in the lengthwise direction L of the reference electrode 312. The heat transfer member 38 is placed in contact with a portion of the reference electrode 312 and a portion of the solid electrolyte body 31.

The heat transfer member 38 is arranged in contact with the solid electrolyte body 31 through the through-hole 315 and also in contact with the inner wall of the through hole 315 of the reference electrode 312. In other words, the heat transfer member 38 is shaped to continuously overlap the surfaces of the solid electrolyte body 31 and the reference electrode 312.

The contact of the heat transfer member 28 with the reference electrode 312 and the solid electrolyte body 31 offers substantially the same beneficial advantages as those in the fifth embodiment.

Other arrangements of the gas sensor 1 and beneficial advantages offered by the gas sensor 1 are identical with those in the first embodiment. In FIG. 28, the same reference numbers as employed in the first embodiment refer to the same or similar parts, and explanation thereof in detail is omitted.

### Seventh Embodiment

The sensor device 2 in the seventh embodiment is a modification of that in the first embodiment. The sensor device 2 has the heat transfer member 38 disposed on the surface of the sensor electrode 311. We studied different locations on the heat transfer member 38 on the surface of the sensor electrode 311 and have concluded that it is undesirable that the heat transfer member 38 is located on a portion of the sensor electrode 311 where after passing through the diffusion resistor 32, the measurement gas G first hits the heat transfer member 38.

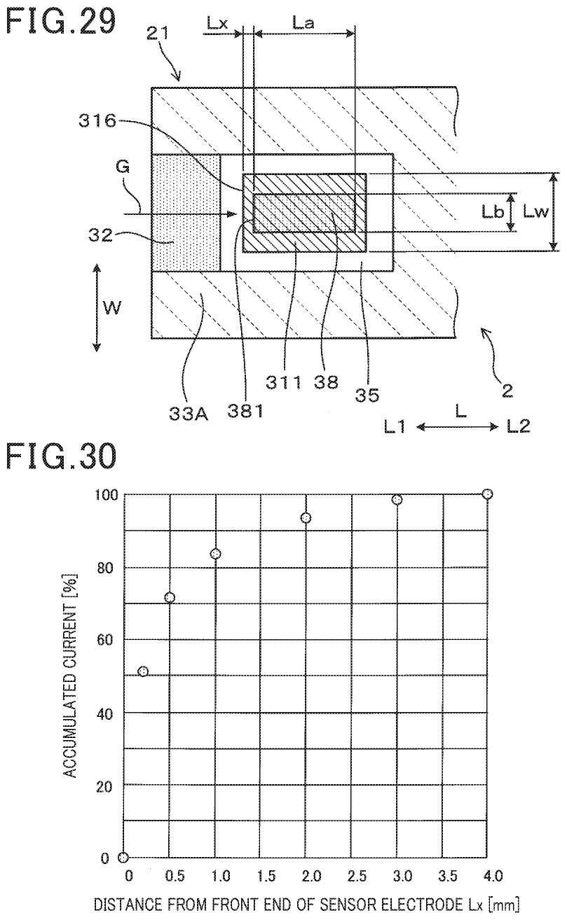

The sensor device 2, as illustrated in FIG. 29, has the diffusion resistor 32 disposed in the front end L1 of the first insulator 33A The measurement gas G enters the gas chamber 35 through the diffusion resistor 32 at the front end L1 of the sensor device 2. The heat transfer member 38 is placed in contact with a portion of the surface of the sensor electrode 311. The heat transfer member 38 has a transverse section area, as extending perpendicular to the stacking direction D, which is smaller than that of the sensor electrode 311 perpendicular to the stacking direction D.

The heat transfer member 38 is, as can be seen in FIG. 29, placed in contact with a portion of the sensor electrode 311 other than a front end portion (i.e., a left portion, as viewed in FIG. 29) of the sensor electrode 311 closest to the diffusion resistor 32 in the lengthwise direction L. The front end portion of the sensor electrode 311 is not in contact with the heat transfer member 38 so that it is directly exposed to the measurement gas G.

FIG. 30 represents a relation between a distance toward the base end L2 of the sensor electrode 311 in the lengthwise direction L from the front end 316 of the sensor electrode 311 which is located most upstream in a flow of the measurement gas G entering the sensor device 2 and an amount of electric current accumulated in the sensor electrode 311 when electric current flows between the sensor electrode 311 and the reference electrode 312 for measuring the concentration of the measurement gas G. In the sensor electrode 311, the electrochemical reaction is developed in sequence from the front end 316 the measurement gas G first contacts. The electrochemical reaction proceeds weakly toward the rear end L2 of the sensor electrode 311 in the lengthwise direction L.

If the surface of the front end portion of the sensor electrode 311 is covered or enclosed by the heat transfer member 38, it will cause oxygen which will usually be decomposed and sensed as electric current on the front end portion to be undesirably diffused. It is, therefore, preferable that the surface of the front end portion of the sensor electrode 311 is separate from the heat transfer member 38.

The accumulated current indicated in the graph of FIG. 30 is an amount of electric current which is accumulated and increased from the front end 316 to the rear end L2 of the sensor electrode 311 and expressed in percentage where 100% represents an amount of electric current flowing in the whole of the sensor electrode 311. The graph of FIG. 30 shows that the accumulated current is at 0% at the front end 316 of the sensor electrode 311, while that in a portion of the sensor electrode 311 4 mm away from the front end 316 toward the base end L2 is at approximately 100%.

In other words, the amount of current flowing in the sensor electrode 311 is maximized at a distance of 4 mm or more from the front end 316 to the rear end L2 of the sensor electrode 311. Required electrochemical reaction is usually developed on the sensor electrode 311 if the accumulated current which is a minimum of 50% is derived in the sensor electrode 311. The heat transfer member 38 may be located at a distance of 0.2 mm or more from the front end 316 of the sensor electrode 311 toward the rear end L2 of the sensor device 2 in the lengthwise direction L. When it is required to derive the accumulated current which is at least 70% or more, the heat transfer member 38 is preferably arranged at a distance of 0.5 mm or more from the front end 316 of the sensor electrode 311 in the lengthwise direction L.

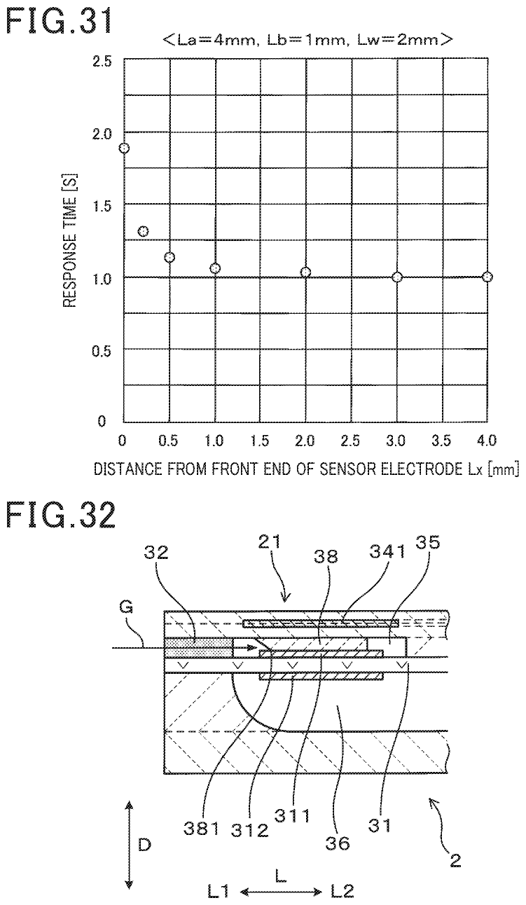

FIG. 31 is a graph which demonstrates results of simulations about response times it takes for the sensor device 2 to detect a change in air-fuel ratio (A/F) of the measurement gas G from 15 to 14 for different locations of the heat transfer member 38 relative to the sensor electrode 311 in the lengthwise direction L. The simulations employed the sensor device 2 having the following dimensions. The length of the heat transfer member 38 is 4 mm in the lengthwise direction L. The width of heat transfer member 38 is 1 mm in the width-wise direction W. The width of the sensor electrode 311 is 2 mm in the width-wise direction W. A distance between the front end 316 of the sensor electrode 311 and the front end 318 of the heat transfer member 38 in the lengthwise direction L is expressed by Lx mm. The distance Lx was changed between 0 and 4 mm in the simulations.

In the graph of FIG. 31, the response time is expressed by a change in time (sec.) with a change in the distance Lx where 1 (sec.) is a reference response time when the distance Lx is 4 mm. The graph shows that when the distance Lx is 0 mm the response time is 1.8 s, and when the distance Lx is 0.2 mm, the response time is 1.3 s. It is, therefore, preferable that the heat transfer member 38 is arranged to have the front end 381 which is located upstream in a flow of the measurement gas G, physically contacts the sensor electrode 311, and is arranged at a distance of 0.2 mm or more away from the front end 316 of the sensor electrode 311 toward the base end L2 of the sensor electrode 311 in the lengthwise direction L. It is more preferable that the front end 381 of the heat transfer member 38 which physically contacts the sensor electrode 311 is located at a distance of 0.5 mm or more away from the front end 316 of the sensor electrode 311 toward the base end L2 of the sensor electrode 311 in the lengthwise direction L.

The heat transfer member 38 may be designed in a cylindrical shape which extends straight in the stacking direction D of the solid electrolyte body 31 and has a cross section, as taken in a direction perpendicular to the stacking direction D. The heat transfer member 38 may alternatively be, as illustrated in FIG. 32, designed to have a sectional area which extends in a planar direction of the solid electrolyte body 31 and decreases as approaching the sensor electrode 311. In other words, the heat transfer member 38 may be shaped to have a trapezoidal section extending in the stacking direction D. For example, the heat transfer member 38 may have a tapered front portion, in other words, a front surface inclined to have a front edge and a rear edge located closer to the base end L2 of the sensor electrode 311 than the front edge is. In this case, it is preferable that the front end 381 of the heat transfer member 38 which physically contacts the sensor electrode 311 is located at a distance of 0.2 mm or more from the front end 316 of the sensor electrode 311 to the base end L2 of the sensor electrode 311 in the lengthwise direction L.

Other arrangements of the gas sensor 1 and beneficial advantages offered by the gas sensor 1 are identical with those in the first embodiment. In FIGS. 29 to 32, the same reference numbers as employed in the first embodiment refer to the same or similar parts, and explanation thereof in detail is omitted.

### Verification Test

We performed variation tests using the sensor device 1 in the first embodiment which has heater 34 embedded in the first insulator 33A and the heat transfer member 38 disposed in the first insulator 33A and measured an activation time that is a time required to heat the sensor device 2 to bring the temperature thereof into agreement with an operating temperature (i.e., activation temperature). We also employed a comparative gas sensor which has the heater 34 embedded in the second insulator 33B and is not equipped with the heat transfer member 38 and measured the activation time required to heat the comparative gas sensor up to the operating temperature. The verification texts show that the activation time required by the gas sensor 1 equipped with the sensor device 1 in the first embodiment is shortened to be approximately 30% of that required by the comparative gas sensor where the activation time in the comparative gas sensor is expressed by 100% and that a period of time required to energize the heater 34 of the sensor device 2 in the first embodiment to increase the temperature of the sensor device 2 from an ambient temperature (25°) to the operating temperature (e.g., 650°) is 1 sec. or less.

In the verification tests, we also measured an amount of electric power consumed by the sensor device 2 in the first embodiment to constantly keep the sensor device 2 at the operating temperature. We also prepared a comparative gas sensor equipped with a conventional sensor device and measured an amount of electric power consumed by the conventional gas sensor to constantly keep the conventional sensor device at the operating temperature in the same way. Results of the tests show that the amount of electric power consumed by the gas sensor 1 in the first embodiment is approximately 50% of that consumed by the comparative gas sensor where the amount of electric power consumed by the comparative gas sensor where the amount of electric power consumed by the conventional gas sensor is defined as 100%.

In the verification tests, we also measured the activation time that is a time interval between start of energization of the heater 34 and when the operating temperature is reached using two types of gas sensors: one being the gas sensor 1 equipped with the sensor device 2 in the third embodiment which has the heat transfer member 38 laid to overlap the heating element 341 in the stacking direction D, and the second being the gas sensor 1 equipped with the sensor device 2 in the first embodiment which has the heat transfer member 38 placed out of overlap with the heating element 341 in the stacking direction D. Results of the tests show that the activation time in the sensor device 2 in the third embodiment is approximately 30% of that in the first embodiment.

While the present invention has been disclosed in terms of the preferred embodiment in order to facilitate better understanding thereof, it should be appreciated that the invention can be embodied in various ways without departing from the principle of the invention. Therefore, the invention should be understood to include all possible embodiments and modifications to the shown embodiment which can be embodied without departing from the principle of the invention as set forth in the appended claims.

What is claimed is:

1. A gas sensor comprising:
a sensor device which is of a planar shape; and
a heat transfer member,
wherein the sensor device includes,
a solid electrolyte body which has oxygen ion conductivity,
a pair of electrodes which are disposed on a surface of the solid electrolyte body,
an insulator which is stacked on the solid electrolyte body,
a gas space which is enclosed by the insulator and located adjacent the solid electrolyte body, in which one of the electrodes is disposed, and into which a measurement gas or a reference gas is introduced, and
a heater which includes a heating element and a pair of leads connecting with the heating element, the heating element being energized to produce heat when supplied with electric power and laid to at least partially overlap the electrodes on the solid electrolyte body in a stacking direction in which the solid electrolyte body and the insulator are stacked, the heater being embedded in the insulator,
wherein the heat transfer member is made of a dense metallic oxide which blocks passage of the measurement gas therethrough, the heat transfer member being held between the insulator and one of the electrodes or among the insulator, one of the electrodes, and the solid electrolyte body within a portion of the gas space, the heat transfer member working to achieve transfer of the heat from the heating element to the solid electrolyte body and the electrodes.

2. The gas sensor as set forth in claim 1, wherein the gas space is defined by a gas chamber into which the measurement gas is delivered at a given diffusion rate through a diffusion resistor and which has disposed therein a sensor electrode that is one of the electrodes and exposed to the measurement gas, wherein the heater is embedded in the insulator and faces the sensor electrode, and wherein the heat transfer member is held between the insulator in which the heater is embedded and the sensor electrode or among the insulator in which the heater is embedded, the sensor electrode, and the solid electrolyte body within a portion of the gas chamber.

3. The gas sensor as set forth in claim 1, wherein the gas space is defined by a reference gas duct into which the reference gas is delivered and which has disposed therein a reference electrode that is one of the electrodes and exposed to the reference gas, wherein the heater is embedded in the insulator forming the reference gas duct therein and faces the reference electrode, and wherein the heat transfer member is held between the insulator in which the heater is embedded and the reference electrode or among the insulator in which the heater is embedded, the reference electrode, and the solid electrolyte body within a portion of the reference gas duct.

4. A gas sensor comprising:
a sensor device which has a length and is of a planar shape; and
a heat transfer member,
wherein the sensor device includes,
a solid electrolyte body which has oxygen ion conductivity, the solid electrolyte body having a length with a front end portion and a rear end portion, the solid electrolyte body also having a first major surface exposed to a measurement gas and a second major surface exposed to a reference gas,
a sensor electrode which is disposed on the first major surface of the front end portion of the solid electrolyte body,
a reference electrode which is disposed on the second major surface of the front end portion of the solid electrolyte body,
a first insulator which is stacked on the first major surface of the solid electrolyte body,
a heater which includes a heating element and a pair of leads connecting with rear ends of the heating element, the heating element being energized to produce heat when supplied with electric power and laid to at least partially overlap the sensor electrode and the reference electrode in a stacking direction in which the solid electrolyte body and the first insulator are stacked, the heater being embedded in the first insulator,
a gas chamber which is formed in the first insulator and located adjacent the first major surface of the solid electrolyte body, the gas chamber having the sensor electrode disposed therein,
a diffusion resistor which is arranged in the first insulator in communication with the gas chamber and through which the measurement gas is delivered into the gas chamber at a given diffusion rate,
a second insulator which is staked on the second major surface of the solid electrolyte body, and
a reference gas duct which is formed in the second insulator and located adjacent the second surface of the solid electrolyte body and extends from a rear end opening formed in the second insulator to a portion of the second insulator to which the reference electrode is exposed, the rear end opening having the measurement gas delivered therethrough into the reference gas duct,
wherein the heat transfer member is made of a dense metallic oxide which blocks passage of the measurement gas therethrough, the heat transfer member being held between the first insulator and the sensor electrode or among the first insulator, the sensor electrode, and the solid electrolyte body within a portion of the gas chamber, the heat transfer member working to achieve transfer of the heat from the heating element to the solid electrolyte body, the sensor electrode, and the reference electrode.

5. A gas sensor comprising:
a sensor device which has a length and is of a planar shape; and
a heat transfer member,
wherein the sensor device includes,
a first solid electrolyte body which has oxygen ion conductivity, the first solid electrolyte body having a length with a front end portion and a rear end portion aligned with the first end portion in a lengthwise direction of the sensor device, the first solid electrolyte body also having a first pump electrode and a second pump electrode which are disposed on the front end portion of the first solid electrolyte body and face each other,
a second solid electrolyte body which is arranged to face the first solid electrolyte body and has oxygen ion conductivity, the second solid electrolyte body having a length with a front end portion and a rear end portion aligned with the first end portion in the lengthwise direction, the second solid electrolyte body also having a sensor electrode and a reference electrode which are disposed on the front end portion of the second solid electrolyte body and face each other,
a first insulator which is stacked on a major surface of the first solid electrolyte body on which the first pump electrode is disposed,
a second insulator which is interposed between a major surface of the first solid electrolyte body on which the second pump electrode is disposed and a major surface of the second solid electrolyte body on which the sensor electrode is disposed,
a third insulator which is stacked on a major surface of the second solid electrolyte body on which the reference electrode is disposed,
a heater which includes a heating element and a pair of leads connecting with rear ends of the heating element, the heating element being energized to produce heat when supplied with electric power and laid to at least partially overlap the first pump electrode, the second pump electrode, the sensor electrode, and the reference electrode in a stacking direction in which the solid electrolyte body, the first insulator, the second insulator, and the third insulator are stacked, the heater being embedded in the third insulator,
a gas chamber which is enclosed by the first solid electrolyte body, the second solid electrolyte body, and the second insulator and in which the second pump electrode and the sensor electrode are disposed, and
a diffusion resistor which is arranged in the second insulator in communication with the gas chamber and through which the measurement gas is delivered into the gas chamber at a given diffusion rate,
wherein the heat transfer member is made of a dense metallic oxide which blocks passage of the measurement gas therethrough, the heat transfer member being held between the second pump electrode and the sensor electrode or among the second pump electrode, the first solid electrolyte body, the sensor electrode, and the second solid electrolyte body within a portion of the gas chamber, the heat transfer member working to achieve transfer of the heat from the heating element to the first solid electrolyte body, the first pump electrode, and the second pump electrode.

6. The gas sensor as set forth in claim 1, wherein the heating element is made of a meandering conductive wire, and wherein the heat transfer member is laid to overlap a portion of the heating element in the stacking direction.

7. The gas sensor as set forth in claim 1, wherein one of the electrodes has formed therein a through-hole or a cut-out extending therethrough in the stacking direction, and wherein the heat transfer member is placed in contact with the solid electrolyte body through the through-hole or the cut-out and also in contact with an inner wall of the electrode which defines the through-hole or the cut-out.

8. The gas sensor as set forth in claim 2, wherein the sensor electrode has formed therein a through-hole or a cut-out extending therethrough in the stacking direction, and wherein the heat transfer member is placed in contact with the solid electrolyte body through the through-hole or the cut-out and also in contact with an inner wall of the sensor electrode which defines the through-hole or the cut-out.

9. The gas sensor as set forth in claim 3, wherein the reference electrode has formed therein a through-hole or a cut-out extending therethrough in the stacking direction, and wherein the heat transfer member is placed in contact with the solid electrolyte body through the through-hole or the cut-out and also in contact with an inner wall of the reference electrode which defines the through-hole or the cut-out.

10. The gas sensor as set forth in claim 4, wherein the first insulator has a length with a front end portion and a rear end aligned in a lengthwise direction of the sensor device, wherein the diffusion resistor is disposed in the front end portion of the first insulator, wherein a sectional area of the heat transfer member extending perpendicular to the stacking direction is smaller than that of the sensor electrode, and wherein the sensor electrode has a front end portion of a length thereof extending in the lengthwise direction, the front end portion of the sensor electrode being out of contact with the heat transfer member, so that the front end portion of the sensor electrode is exposed to the measurement gas.

11. The gas sensor as set forth in claim 10, wherein the heat transfer member has a front end which is located upstream in a flow of the measurement gas and contacts the sensor electrode, the front end being located at a distance of 0.2 mm or more away from a front end of the sensor electrode which is located upstream in the flow of the measurement gas toward a rear end of the sensor device in the lengthwise direction.
